(19) United States
(12) Patent Application Publication
(10) Pub. No.: US 2014/0043369 A1
(43) Pub. Date: Feb. 13, 2014

(54) Displays and Display Pixel Adaptation

(71) Applicants: Marc Albrecht, San Francisco, CA (US); Ulrich Barnhoefer, Cupertino, CA (US); Gabriel Marcu, San Jose, CA (US); Sandro H. Pintz, Menlo Park, CA (US)

(72) Inventors: Marc Albrecht, San Francisco, CA (US); Ulrich Barnhoefer, Cupertino, CA (US); Gabriel Marcu, San Jose, CA (US); Sandro H. Pintz, Menlo Park, CA (US)

(21) Appl. No.: 13/569,940

(22) Filed: Aug. 8, 2012

(51) Int. Cl. G09G 5/10

(52) U.S. Cl. 345/690

(57) ABSTRACT

An electronic device may include a display and display control circuitry. The display may be calibrated to reduce color non-uniformity in the display. Display calibration information may be obtained during manufacturing and may be stored in the electronic device. The display calibration information may include color-specific, intensity-specific, location-specific correction factors. During operation of the display, display control circuitry may receive pixel data to be displayed by each pixel in the display. The pixel data may include color information and intensity information for each pixel. Based on the color information for each pixel, the intensity information for each pixel, and the location of each pixel in the display, the display control circuitry may determine a color-specific, intensity-specific, location-specific correction factor to apply to the pixel data for each pixel. Adapted pixel data may be supplied to each pixel in the display.

### BACKGROUND

This relates to generally to electronic devices with displays, and, more particularly, to electronic devices with calibrated displays.

Electronic devices such as portable computers, media players, cellular telephones, set-top boxes, and other electronic equipment are often provided with displays for displaying visual information.

Due to various factors, colors which are meant to appear uniform on a display may not actually appear uniform to a user. For example, a white background on a display may have portions which appear slightly yellow or slightly blue. Displays are sometimes calibrated to reduce color non-uniformity.

Conventional calibration methods for correcting color non-uniformity in a display typically require an excessive amount of measurement and a large amount of memory. For example, a three-dimensional look up table (“3D LUT”), which is used to generate adapted pixel values based on input pixel values, typically requires well over 4,000 measurements for a display with 8-bit resolution per color. The amount of memory required to store a table of this size may be undesirably large and may increase the costs associated with manufacturing a display.

It would therefore be desirable to be able to provide improved calibration systems for calibrating electronic devices with color displays.

### SUMMARY

An electronic device may include a display and display control circuitry. The display may be calibrated during manufacturing using a calibration system. The calibration system may include calibration computing equipment coupled to a light sensor and may be used to gather display performance information from the display. The light sensor may be used to capture images of a display while the display is operated in different modes of operation.

Display performance information may include color information and intensity information measured at different locations on the display. Calibration computing equipment may use the color information and intensity information to calculate color-specific, intensity-specific, location-specific correction factors for each different location on the display.

Correction factors may be determined by comparing measured color data a given location on the display with reference color data. The measured color data may include tristimulus values that are based on measured intensities of light at the given location. The reference color data may include color data measured at a reference location on the display or may include predetermined color data such as predetermined tristimulus values.

The color-specific, intensity-specific, location-specific correction factors may be stored in the electronic device. Display control circuitry in the electronic device may use the stored correction factors to perform pixel adaptation during operation of the display.

The display control circuitry may be configured to provide display data to the display. The display data may include color information and intensity information for each pixel. The display control circuitry may be configured to determine correction factor information for each pixel based on the color information, the intensity information, and the location of each pixel in the display.

The correction factor information may include correction factor values that correspond to different colors, intensity levels, and pixel locations on the display. The control circuitry may determine which correction factor values correspond to the color information for each pixel, the intensity information for each pixel, and the location of each pixel on the display. The display control circuitry may use interpolation to determine correction factor information for at least some of the pixels.

Display data for each pixel may include first and second digital display control values. The display control circuitry may determine correction factor information based on a ratio between the first digital display control value and the second digital display control value.

Each pixel may include a red subpixel, a green subpixel, and a blue subpixel. Correction factor information may include a red correction factor for each red subpixel, a green correction factor for each green subpixel, and a blue correction factor for a blue subpixel.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative electronic device such as a portable computer having a calibrated display in accordance with an embodiment of the present invention.

FIG. 2 is a diagram of an illustrative electronic device such as a cellular telephone or other handheld device having a calibrated display in accordance with an embodiment of the present invention.

FIG. 3 is a diagram of an illustrative electronic device such as a tablet computer having a calibrated display in accordance with an embodiment of the present invention.

FIG. 4 is a diagram of an illustrative electronic device such as a computer monitor with a built-in computer having a calibrated display in accordance with an embodiment of the present invention.

FIG. 5 is a diagram of an illustrative electronic device having a calibrated display in accordance with an embodiment of the present invention.

FIG. 6 is a diagram of an illustrative portion of a display showing how colored display pixels may be arranged in rows and columns in accordance with an embodiment of the present invention.

FIG. 7 is a diagram showing illustrative areas of a display that may benefit from pixel adaptation in accordance with an embodiment of the present invention.

FIG. 8 is a diagram of an illustrative calibration system for performing display calibration including calibration computing equipment and a test chamber having a light sensor in accordance with an embodiment of the present invention.

FIG. 9 is a chromaticity diagram showing an illustrative set of representative colors which may be used to calculate color-specific, intensity-specific, location-specific correction factors in accordance with an embodiment of the present invention.

FIG. 10 is a diagram showing illustrative data that may be collected during a first data collection phase in accordance with an embodiment of the present invention.

FIG. 11 is a diagram showing illustrative data that may be collected during a second data collection phase in accordance with an embodiment of the present invention.

FIG. 12 is a diagram showing illustrative data that may be used to calculate steady state factors for a given color, intensity level, and location in accordance with an embodiment of the present invention.

FIG. 13 is a diagram showing an illustrative comparison of color data at a given location with color data at a reference location in accordance with an embodiment of the present invention.

FIG. 14 is a diagram showing an illustrative table of color-specific, intensity-specific, location-specific correction factors in accordance with an embodiment of the present invention.

FIG. 15 is a diagram of an illustrative display showing how pixel adaptation may be performed for a display pixel in accordance with an embodiment of the present invention.

FIG. 16 is a flow chart of illustrative steps involved in providing an electronic device with pixel adaptation capabilities in accordance with an embodiment of the present invention.

FIG. 17 is a flow chart of illustrative steps involved in gathering display performance data during calibration operations in accordance with an embodiment of the present invention.

FIG. 18 is a flow chart of illustrative steps involved in using display performance data to calculate color-specific, intensity-specific, location-specific correction factors in accordance with an embodiment of the present invention.

FIG. 19 is a flow chart of illustrative steps involved in performing pixel adaptation using color-specific, intensity-specific, location-specific correction factors in accordance with an embodiment of the present invention.

### DETAILED DESCRIPTION

Electronic devices such as cellular telephones, media players, computers, set-top boxes, wireless access points, and other electronic equipment may include calibrated displays. Displays may be used to present visual information and status data and/or may be used to gather user input data.

Display performance data may be gathered during calibration operations during manufacturing. The display color performance data may be used to calculate color-specific, intensity-specific, location-specific correction factors for a display in an electronic device. The correction factors may be stored in the electronic device and may be used to calibrate the display during operation of the display.

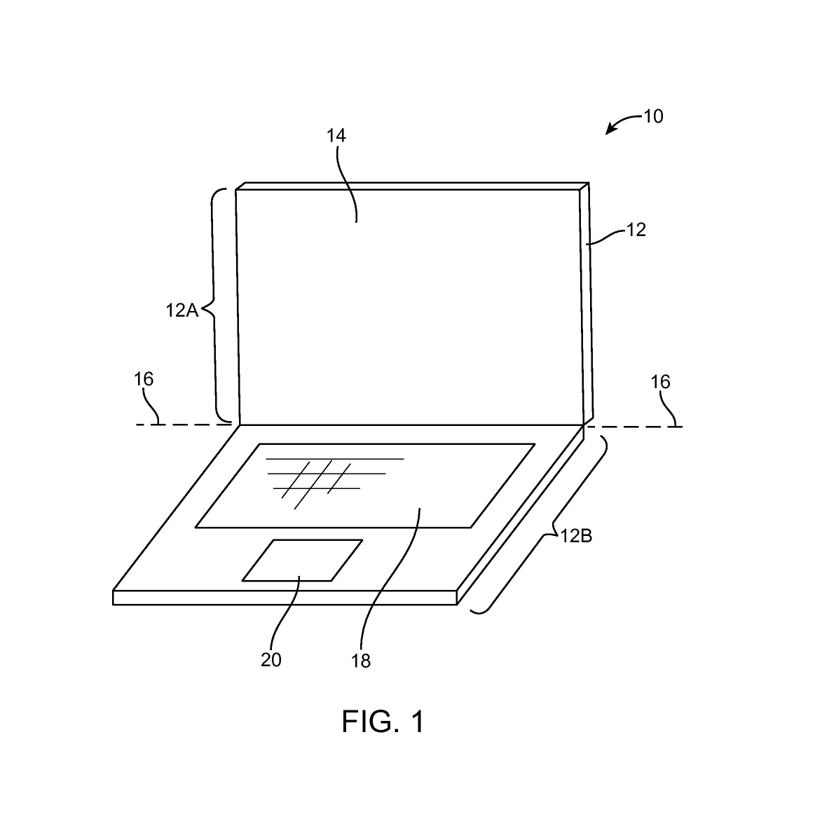

An illustrative electronic device of the type that may be provided with a display is shown in FIG. 1. Electronic device 10 may be a computer such as a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment.

As shown in FIG. 1, device 10 may include a display such as display 14. Display 14 may be a touch screen that incorporates capacitive touch electrodes or other touch sensor components or may be a display that is not touch-sensitive. Display 14 may include image pixels formed from light-emitting diodes (LEDs), organic light-emitting diodes (OLEDs), plasma cells, electrophoretic display elements, electrowetting display elements, liquid crystal display (LCD) components, or other suitable image pixel structures. Arrangements in which display 14 is formed using liquid crystal display pixels are sometimes described herein as an example. This is, however, merely illustrative. Any suitable type of display technology may be used in forming display 14 if desired.

Device 10 may have a housing such as housing 12. Housing 12, which may sometimes be referred to as a case, may be formed of plastic, glass, ceramics, fiber composites, metal (e.g., stainless steel, aluminum, etc.), other suitable materials, or a combination of any two or more of these materials.

Housing 12 may be formed using a unibody configuration in which some or all of housing 12 is machined or molded as a single structure or may be formed using multiple structures (e.g., an internal frame structure, one or more structures that form exterior housing surfaces, etc.).

As shown in FIG. 1, housing 12 may have multiple parts. For example, housing 12 may have upper portion 12A and lower portion 12B. Upper portion 12A may be coupled to lower portion 12B using a hinge that allows portion 12A to rotate about rotational axis 16 relative to portion 12B. A keyboard such as keyboard 18 and a touch pad such as touch pad 20 may be mounted in housing portion 12B.

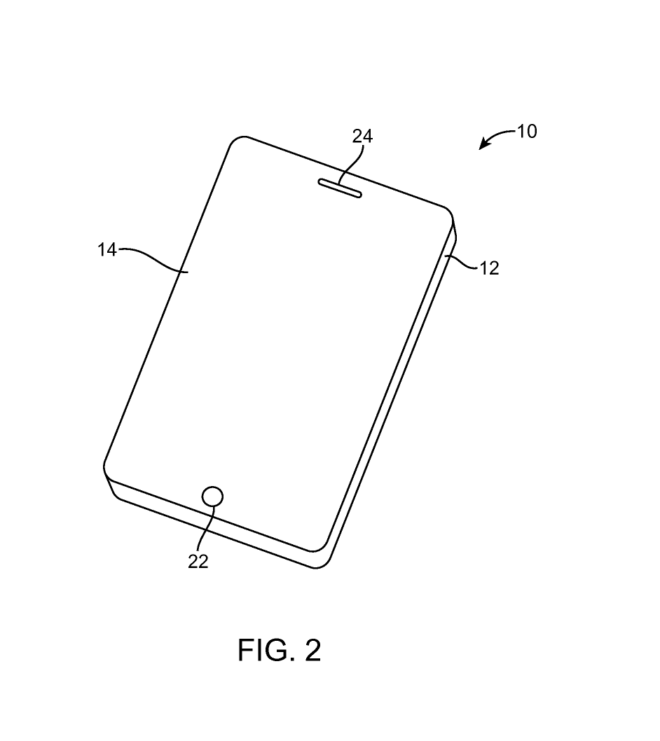

In the example of FIG. 2, device 10 has been implemented using a housing that is sufficiently small to fit within a user's hand (i.e., device 10 of FIG. 2 may be a handheld electronic device such as a cellular telephone). As show in FIG. 2, device 10 may include a display such as display 14 mounted on the front of housing 12. Display 14 may be substantially filled with active display pixels or may have an active portion and an inactive portion. Display 14 may have openings (e.g., openings in the inactive or active portions of display 14) such as an opening to accommodate button 22 and an opening to accommodate speaker port 24.

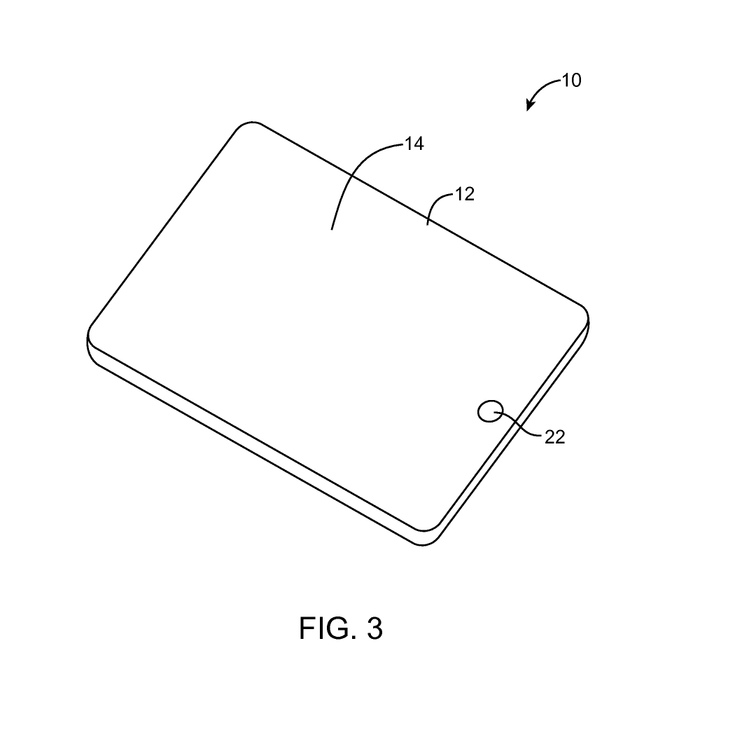

FIG. 3 is a perspective view of electronic device 10 in a configuration in which electronic device 10 has been implemented in the form of a tablet computer. As shown in FIG. 3, display 14 may be mounted on the upper (front) surface of housing 12. An opening may be formed in display 14 to accommodate button 22.

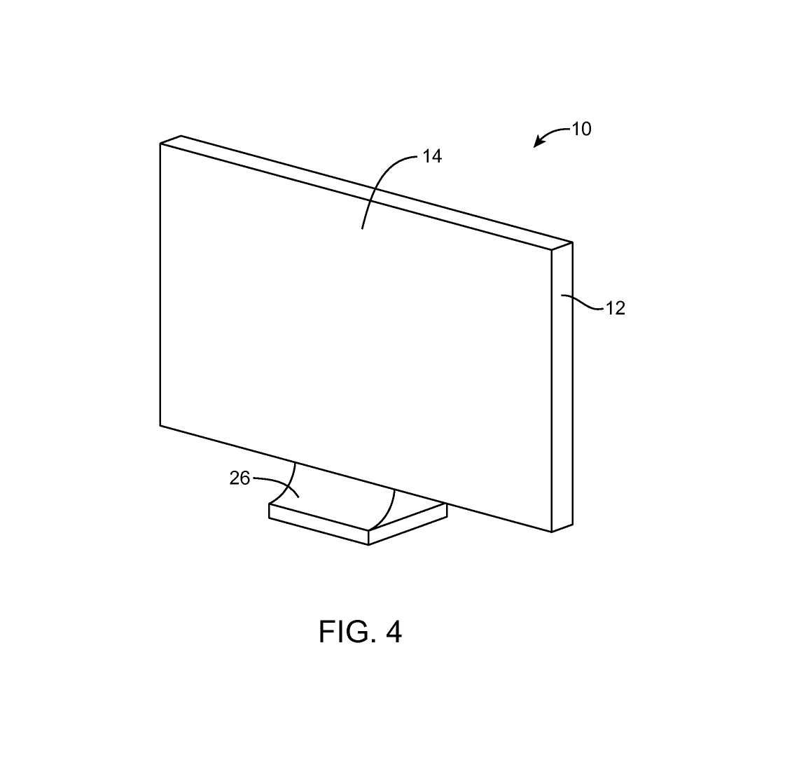

FIG. 4 is a perspective view of electronic device 10 in a configuration in which electronic device 10 has been implemented in the form of a computer integrated into a computer monitor. As shown in FIG. 4, display 14 may be mounted on the front surface of housing 12. Stand 26 may be used to support housing 12.

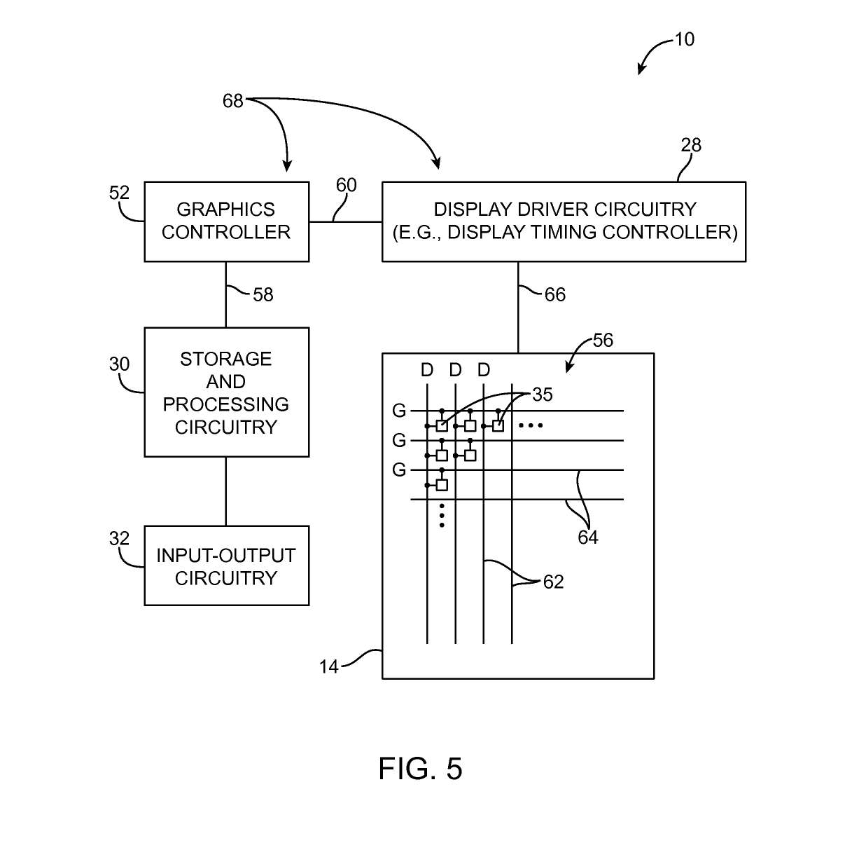

A diagram of electronic device 10 is shown in FIG. 5. As shown in FIG. 5, electronic device 10 may include a display such as display 14 and display control circuitry such as display control circuitry 68. Display control circuitry 68 may include a graphics controller such as graphics controller 52 and display driver circuitry such as display driver circuitry 28. Graphics controller 52, which may sometimes be referred to as a video card or video adapter, may be used to provide video data and control signals to display 14. The video data may include text, graphics, images, moving video content, or other content to be presented on display 14.

Display driver circuitry 28 may be implemented using one or more integrated circuits (ICs) and may sometimes be referred to as a driver IC, display driver integrated circuit, or display driver. Display driver circuitry 28 may include, for example, timing controller 30 (TCON) circuitry such as a TCON integrated circuit. Display driver circuitry 28 may, for example, be mounted on an edge of a thin-film-transistor substrate layer in display 14 (as an example).

Graphics controller 52 may receive video data to be displayed on display 14 from storage and processing circuitry 30 over a path such as path 58. Storage and processing circuitry 30 may include one or more processors such as microprocessors, microcontrollers, digital signal processors, application-specific integrated circuits, or other processing circuits. Storage and processing circuitry may also include storage such as random-access memory, read-only memory, solid state memory in a solid state hard drive, magnetic storage, and other volatile and/or nonvolatile memory.

Circuitry 30 may use input-output circuitry 32 to allow data and user input to be supplied to device 10 and to allow data to be supplied from device 10 to external devices and/or to a user. Input-output circuitry 32 may include input-output devices such as touch screens, buttons, joysticks, click wheels, scrolling wheels, touch pads, key pads, keyboards, microphones, speakers, tone generators, vibrators, cameras, sensors, light-emitting diodes and other status indicators, data ports, etc. A user may control the operation of device 10 by supplying commands through input-output devices and may receive status information and other output from device 10 using the output resources of input-output devices.

Input-output circuitry 32 may include wireless communications circuitry. Wireless communications circuitry may include wireless local area network transceiver circuitry, cellular telephone network transceiver circuitry, and other components for wireless communication.

Display 14 may include a pixel array such as pixel array 56. Pixel array 56 may be controlled using control signals produced by display driver circuitry 28. During operation of device 10, storage and processing circuitry 30 may provide data to display driver circuitry 28 via graphics controller 52. Communications path 60 may be used to convey information between graphics controller 52 and display 14. Display driver circuitry 28 may convert the data that is received on path 60 into signals for controlling the pixels of pixel array 56.

Pixels 35 in pixel array 56 may contain thin-film transistor circuitry (e.g., polysilicon transistor circuitry or amorphous silicon transistor circuitry) and associated structures for producing electric fields across liquid crystal material in display 14. The thin-film transistor structures that are used in forming pixels 35 may be located on a substrate (sometimes referred to as a thin-film transistor layer or thin-film transistor substrate). The thin-film transistor (TFT) layer may be formed from a planar glass substrate, a plastic substrate, or a sheet of other suitable substrate materials.

As shown in FIG. 5, pixel array 56 may include data lines 62 for providing data line signals to columns of display pixels 35 and gate lines 64 for providing gate line signals to rows of pixels 35. The data line signals in pixel array 56 may carry analog image data (e.g., voltages with magnitudes representing pixel brightness levels). During the process of displaying images on display 14, display driver circuitry 28 may receive digital data from graphics controller 52 via path 60 and may produce corresponding analog data on path 66.

To provide display 14 with the ability to display color images, display 14 may include display pixels having color filter elements. Each color filter element may be used to impart color to the light associated with a respective display pixel in the pixel array of display 14. Display 14 may, for example, include a layer of liquid crystal material interposed between a thin-film-transistor layer and a color filter layer (as an example).

Display 14 may include touch circuitry such as capacitive touch electrodes (e.g., indium tin oxide electrodes or other suitable transparent electrodes) or other touch sensor components (e.g., resistive touch technologies, acoustic touch technologies, touch sensor arrangements using light sensors, force sensors, etc.). Display 14 may be a touch screen that incorporates display touch circuitry or may be a display that is not touch sensitive.

Display calibration information such as color-specific, intensity-specific, location-specific correction factors may be loaded onto device 10 during manufacturing. The stored correction factors may be accessed during operation of display 14 to produce calibrated images for a user. Correction factors may be stored in any suitable location in electronic device 10. For example, correction factors may be stored in storage and processing circuitry 30, in graphics controller 52, or in display driver 30 circuitry 28. In one suitable embodiment, a display timing controller (TCON) integrated circuit in circuitry 28 may receive incoming subpixel values from graphics controller 52 and may, based on the received incoming subpixel values, calculate and apply appropriate correction factors to the incoming subpixel values to obtain adapted subpixel values. This is, however, merely illustrative. If desired, display calibration may be performed by graphics controller 52, by storage and processing circuitry 30, and/or by other components in device 10.

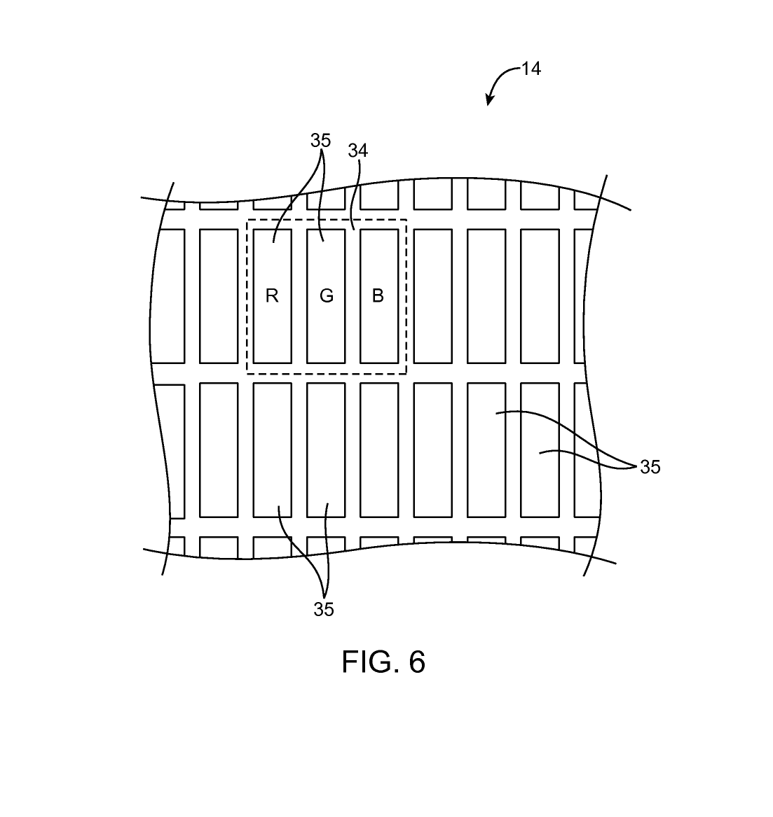

A portion of an illustrative array of display pixels is shown in FIG. 6. As shown in FIG. 6, display 14 may have a pixel array with rows and columns of display pixels 34. There may be tens, hundreds, or thousands of rows and columns of display pixels 34. Each pixel 34 may include colored subpixels such as colored subpixels 35. Each pixel 34 may include, for example, a red (R) subpixel 35, a green (G) subpixel 35, a blue (B) subpixel 35, and/or a subpixel of another color. A red subpixel R, for example, may include a red color filter element over a light generating element (e.g., a liquid crystal pixel element or an OLED pixel element) that absorbs and/or reflects non-red light while passing red light. This is, however, merely illustrative. Pixels 34 may include any suitable structures for generating light of a given color.

Subpixels 35 may include subpixels of any suitable color. For example, subpixels 35 may include a pattern of cyan, magenta, and yellow subpixels, or may include any other suitable pattern of colors. The illustrative example in which subpixels 35 include a pattern of red, green, and blue subpixels is sometimes described herein as an example.

Display driver circuitry such as a display driver integrated circuit and, if desired, associated thin-film transistor circuitry formed on a display substrate layer may be used to produce signals such as data signals and gate line signals (e.g., on data lines and gate lines respectively in display 14) for operating pixels 34 (e.g., turning pixels 34 on and/or off and/or adjusting the intensity of pixels 34). During operation of display 14, display driver circuitry 28 may be used to control the intensity of light displayed by pixels 34 by controlling the values of data signals and gate line signals that are supplied to pixels 34.

Control circuitry included in storage and processing circuitry 30 may be used to provide digital display control values to display driver circuitry in device 10. Digital display control values may be a set of integers (commonly integers with values ranging from 0 to 255) that may be used to control the brightness of pixels 34. Each digital display control value may correspond to an associated intensity level. Display driver circuitry 28 may be used to convert the digital display control values into analog display signals. The analog display signals may be supplied to pixels 34 and may therefore be used to control the brightness of pixels 34. For example, a digital display control value of 0 may result in an “off” pixel while a digital display control value of 255 may result in a pixel operating at a maximum available power.

Digital display control values may include any suitable range of values. For example, digital display control values may be a set of integers ranging from 0 to 64. Arrangements in which digital display control values include integer values ranging from 0 to 255 is sometimes described herein as an example.

Display driver circuitry 28 may be used to concurrently operate pixels 34 of different colors in order to generate light having a color that is a mixture of, for example, primary colors red, green, and blue. As examples, operating red pixels R and blue pixels B at equal intensities may produce light that appears violet, operating red pixels R and green pixels G at equal intensities may generate light that appears yellow, operating red pixels R and green pixels G at maximum intensity while operating blue pixels B at half of maximum intensity may appear “yellowish,” and operating red pixels R, green pixels G and blue pixels B at simultaneously at maximum intensity may generate light that appears white.

In some cases, however, a given color may appear differently in some portions of the display than in other portions of the display. A white background, for example, which is meant to appear uniformly white across the display, may appear slightly yellow in some portions of the display and/or may appear slightly blue in some portions of the display. Other colors may also exhibit non-uniformity across the display.

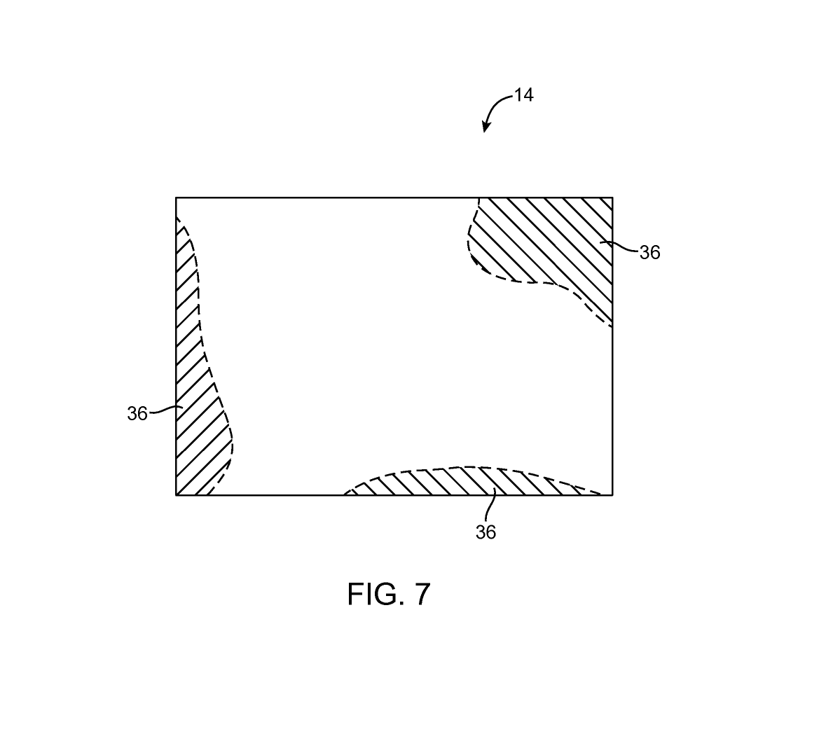

There are various factors that can contribute to color non-uniformity in a display. For example, backlight non-uniformity (e.g., manufacturing variations in the light-emitting diodes of a backlight), cell gap variation (e.g., gaps between adjacent pixel cells), color filter variation, display panel temperature variation, and other factors may contribute to color non-uniformity in a display. As an example, portions of a display such as edge portions 36 of display 14 shown in FIG. 7 may experience higher temperatures than other portions of display 14. This may result in a white screen appearing more “bluish” in higher temperature portions 36 of display 14.

Color non-uniformity in a display may be corrected by applying correction factors to incoming pixel values to generate corresponding adapted pixel values. The adapted pixel values may be used to generate images with increased color uniformity. The adapted pixel values may be generated during operation of the display.

In order to produce electronic devices having display pixel adaptation capabilities, the display in each electronic device may undergo a first calibration process during manufacturing. The first calibration process may include gathering display performance information, processing the display performance information, and using the display performance information to calculate color-specific, intensity-specific, location-specific correction factors. The correction factors may be stored in the electronic device and may be used during operation of the display to produce calibrated images for a user.

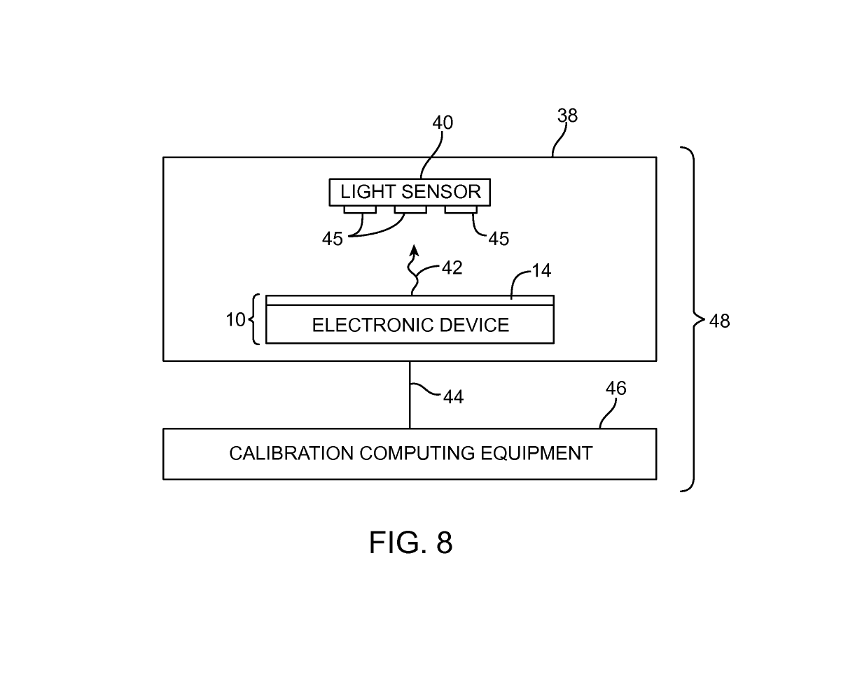

FIG. 8 is a diagram of an illustrative calibration system that may be used in calibrating displays in electronic devices such as electronic device 10. As shown in FIG. 8, calibration system 48 may include calibration computing equipment 46 that is coupled to a test apparatus such as test chamber 38. Calibration computing equipment 46 may include one or more computers, one or more databases, one or more displays, one or more technician interface devices (e.g., keyboards, touch-screens, joysticks, buttons, switches, etc.) for technician control of calibration computing equipment 46, communications components or other suitable calibration computing equipment.

Calibration computing equipment 46 may be coupled to test chamber 38 using a wired or wireless communications path such as path 44.

Test chamber 38 may include a light sensor such as light sensor 40. Light sensor 40 may include one or more light-sensitive components 45 for gathering display light 42 emitted by display 14 during calibration operations. Light-sensitive components 45 in light sensor 40 may include colorimetric light-sensitive components and spectrophotometric light-sensitive components configured to gather colored light.

Light sensor 40 may, for example, be a colorimeter having one or more light-sensitive components 45 each corresponding to an associated set of colored pixels in display 14. For example, a display having red, green and blue display pixels may be calibrated using a light sensor having corresponding red, green, and blue light-sensitive components 45. This is, however, merely illustrative. A display may include display pixels for emitting colors other than red, green, and blue, and light sensor 40 may include light-sensitive components 45 sensitive to colors other than red, green, and blue, may include white light sensors, or may include spectroscopic sensors.

Light sensor 40 may be used by system 48 to convert display light 42 into display performance data for calibrating the performance of displays such as display 14. For example, light sensor 40 may be used to capture images of display 14 while display 14 is operated in different modes of operation. Images captured by light sensor 40 may be provided to calibration computing equipment 46. Each captured image may contain display performance information. Display performance information may include, for example, data corresponding to display light intensities as a function of digital display control values (e.g., measured intensity of red light as a function of the digital display control values supplied to red pixels).

Display performance information may include color data such as X, Y, and Z tristimulus values. Tristimulus values may be calculated based on measured intensities of light at a particular location on display 14. Color data associated with a particular location on display 14 may be compared with color data associated with a reference location on display 14. The comparison of color data may be used to calculate correction factors for that particular location on display 14.

Test chamber 38 may, if desired, be a light-tight chamber that prevents outside light (e.g., ambient light in a testing facility) from reaching light sensor 40 during calibration operations.

During calibration operations, device 10 may be placed into test chamber 38 (e.g., by a technician or by a robotic member). Calibration computing equipment 46 may be used to operate device 10 and light sensor 40 during calibration operations. For example, calibration computing equipment 46 may issue a command (e.g., by transmitting a signal over path 44) to device 10 to operate some or all pixels of display 14. While device 10 is operating the pixels of display 14, calibration computing equipment 46 may operate light sensor 40 to gather display performance data. Display performance data may include, for example, measured intensities of red light emitted from display 14, measured intensities of green light emitted from display 14, and measured intensities of blue light emitted from display 14.

Display 14 may be operated in one or more calibration sequences during calibration operations. Each calibration sequence may correspond to a different color. In a first data collection phase of calibration operations, display 14 may, for example, be operated in a first series of calibration sequences such as a red calibration sequence, a green calibration sequence, and a blue calibration sequence. A red calibration sequence may include operating red pixels at different power levels while green and blue pixels are turned off, a blue calibration sequence may include operating green pixels at different power levels while red and blue pixels are turned off, and a blue calibration sequence may include operating blue pixels at different power levels while red and green pixels are turned off. A given calibration sequence may include measurements at, for example, five different power levels, ten different power levels, fifteen different power levels, more than fifteen different power levels, less than fifteen different power levels, etc.

During a second data collection phase of calibration operations, display 14 may be operated in a series of calibration sequences corresponding to additional colors. The additional colors may include any suitable color. A “color” may be defined by the relative intensity ratios of the colored pixels that make up the color (e.g., “brightness” ratios). For example, in a display having red, green, and blue pixels, a color may be defined by the brightness ratio of red pixels to green pixels, the brightness ratio of green pixels to blue pixels, and the brightness ratio of red pixels to blue pixels (or any other suitable set of brightness ratios from which the brightnesses of red, green, and blue pixels relative to each other may be determined).

As an example, a “greenish blue” color may be defined by a 1:2 brightness ratio of red pixels to green pixels, a 2:3 brightness ratio of green pixels to blue pixels, and a 1:3 brightness ratio of red pixels to blue pixels. As another example, a “yellowish” color may be defined by a 1:2 ratio of blue pixels to green pixels, a 1:2 ratio of blue pixels to red pixels, and a 1:1 ratio of red pixels to green pixels. As yet another example, a “neutral” color may be defined by equal brightness levels of red, green, and blue pixels (e.g., a 1:1 brightness ratio of red pixels to green pixels, a 1:1 brightness ratio of green pixels to blue pixels, and a 1:1 ratio of blue pixels to red pixels).

Each calibration sequence in the second data collection phase may correspond to a different color. For example, a “greenish blue” calibration sequence may include operating red, green, and blue pixels at different power levels while maintaining the relative brightness ratios corresponding to the greenish blue color. Each calibration sequence may include measurements at, for example, five different power levels, ten different power levels, fifteen different power levels, more than fifteen different power levels, less than fifteen different power levels, etc. The series of calibration sequences in the second data collection phase may include any suitable number of calibration sequences. For example, the second data collection phase may include five calibration sequences (e.g., five calibration sequences corresponding respectively to five different colors), may include ten calibration sequences (e.g., ten calibration sequences corresponding respectively to ten different colors), more than ten calibration sequences, less than ten calibration sequences, etc. If desired, the second data collection phase may be omitted and display 14 may only be operated in a first series of calibration sequences (e.g., red, green, and blue calibration sequences).

The display performance data collected during each calibration sequence may be used to calculate correction factors for each shade of the particular color associated with that calibration sequence. For example, a “magenta” calibration sequence may be used to calculate a set of correction factors for each measured shade (e.g., each power level at which a measurement is taken) of magenta, a “bluish green” calibration sequence may be used to calculate a set of correction factors for each measured shade of bluish green, etc. Thus, the set of colors for which data is collected during calibration operations may dictate the set of colors for which correction factors will later be calculated. Similarly, the power levels at which measurements are taken in each calibration sequence may determine the intensity levels for which correction factors will later be calculated.

With this type of configuration, the correction factors which are applied to incoming subpixel values during operation of the display may be color-specific and intensity-specific. For example, if the combination of brightness ratios associated with incoming subpixel values corresponds to a “magenta” color at maximum intensity, then the correction factors which have been calculated specifically for magenta at maximum intensity may be applied to the incoming subpixel values to produce an adapted set of subpixel values.

If desired, a set of correction factors may be calculated for every color (e.g., every different combination of relative brightness ratios) and/or for every shade of a given color. Display 14 may be operated in a corresponding calibration sequence for every color and intensity value for which correction factors are to be calculated.

If desired, correction factors may be calculated for a set of representative colors and for a selected number of shades of each representative color. The set of representative colors may include any suitable color and the selected number of shades may include any suitable shade. Storing correction factors for a set of representative colors and a selected number of shades of each color may require less storage space in an electronic device than storing correction factors for all possible colors and all possible shades of each color. This is, however, merely illustrative. If desired, correction factors may be calculated for all possible colors, for substantially all possible colors, for primary colors only (e.g., red, green, and blue), for a representative set of colors, for every shade of each color, for a selected number of shades of each color, for only the maximum brightness of each color, etc.

A representative set of colors may, for example, include neutral colors (e.g., colors having equal intensities of red, green, and blue light), may include saturated colors (e.g., saturated primary colors and/or saturated secondary colors), may include mid-tone colors (e.g., colors between neutral colors and saturated colors), and/or may include other suitable colors.

Calibration computing equipment 46 may receive display performance data (e.g., display performance data corresponding to captured images of display 14) from light sensor 40 over path 44. Calibration computing equipment 46 may be used to process the gathered data and to calculate color-specific, intensity-specific, location-specific correction factors based on the display performance data. Processing steps may include, for example, applying one or more filters to the images of display 14 gathered by light sensor 40. Filtering techniques that may be applied to images gathered by light sensor 40 include, for example, median filtering (e.g., 2D median filtering) and low-pass filtering (e.g., low-pass/average filtering techniques).

Processing steps performed by calibration computing equipment 46 may include, for example, applying filters (e.g., 2D median filters and low-pass/average filters) to optimize the radiometric resolution of images captured by light sensor 40. The radiometric resolution of each image captured by light sensor 40 may be optimized (e.g., reduced) such that each image is composed of a number of reduced resolution pixels. A reduced resolution pixel may be a location on the display for which display performance information is used to calculate a set of correction factors. Correction factors may be calculated for each reduced resolution pixel on display 14.

With this type of configuration, the correction factors which are applied to incoming subpixel values during operation of the display may be location-specific (e.g., may be location-specific in addition to being color-specific and intensity-specific). For example, the correction factors applied to incoming subpixel values associated with a given pixel may be determined based on the location of the given pixel.

The resolution of each image captured by light sensor 40 may be optimized depending on the areas of display 14 that tend to exhibit greater color non-uniformity. For example, if it is determined that display 14 exhibits greater color non-uniformity at the edges, then the resolution of each image captured by light sensor 40 may be optimized to have greater resolution at the edges than at other portions of the display. This may in turn allow for a greater concentration of locations at the edges of a display for which correction factors will be calculated. This is, however, merely illustrative. If desired, correction factors may be calculated for any suitable number of locations on a display. The locations on a display for which correction factors are calculated may be uniformly distributed across the display or may be distributed non-uniformly in any suitable manner. In any case, the filtering techniques employed by calibration computing equipment 46 may be used to reduce the radiometric resolution of each image captured by light sensor 40 based on the desired locations for which correction factors are to be calculated.

Display performance data gathered by calibration computing equipment 46 may be used to calculate color-specific, intensity-specific, location-specific correction factors for display 14. In one suitable embodiment, the correction factors may be calculated using device 10 during operation of display 14. With this type of configuration, a set of correction factors may be calculated on-the-fly for each set of incoming subpixel values associated with a given pixel on the display. The correction factors may be based on the color to be displayed by that pixel, the intensity of light to be displayed by that pixel, and the location of that pixel on the display. The calculated correction factors may be applied to the incoming subpixel values to obtain adapted subpixel values during operation of the display. To achieve on-the-fly calculation of correction factors, display performance data gathered during calibration operations may be stored on device 10 using storage and processing circuitry 30 and/or using display control circuitry 68 (FIG. 5). Display performance data may, for example, be stored in volatile or non-volatile memory associated with circuitry 30 and/or circuitry 68 for access by software running on circuitry 30 and/or circuitry 68. If desired, display performance data may be hard coded into firmware associated with display 14 (e.g., display driver circuitry 28 associated with display 14). The stored performance data may be used to calculate color-specific, intensity-specific, location-specific correction factors in real-time for each set of incoming subpixel values.

In another suitable embodiment, color-specific, intensity-specific, location-specific correction factors may be calculated using external equipment (e.g., using calibration computing equipment 46 and/or other computing equipment external to device 10). The calculated correction factors may be stored in device 10 and may be used during operation of display 14 to display calibrated images for a user. With this type of configuration, the set of correction factors applied to each set of incoming subpixel values associated with a given pixel may be determined based on the correction factors already stored in device 10. Correction factors may be applied to the incoming subpixel values to obtain adapted subpixel values during operation of the display. Correction factors calculated during calibration operations may be stored in device 10 using storage and processing circuitry 30 and/or using display control circuitry 68 (FIG. 5). Correction factors may, for example, be stored in volatile or non-volatile memory associated with circuitry 30 and/or circuitry 68. If desired, correction factors may be hard coded into firmware associated with display 14 (e.g., display driver circuitry 28 associated with display 14). The stored correction factors may be used during operation of the display to generate adapted subpixel values for each set of incoming subpixel values.

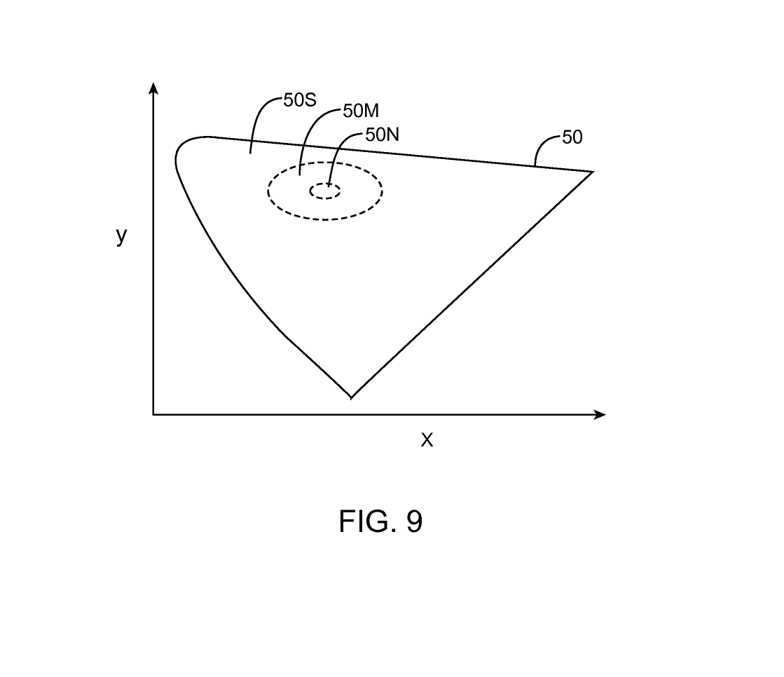

FIG. 9 is a chromaticity diagram showing a two-dimensional projection of a color space. The color generated by a display such as display 14 may be represented by the chromaticity values x and y. The chromaticity values may be computed by transforming, for example, three color intensities (e.g., intensities of colored light emitted by a display) such as red intensity, blue intensity, and green intensity into three tristimulus values X, Y, and Z and normalizing the first two tristimulus values X and Y (e.g., by computing x=X/(X+Y+Z) and y=Y/(X+Y+Z) to obtain normalized x and y values). Transforming color intensities into tristimulus values may be performed using transformations defined by the International Commission on Illumination (CIE) or using any other suitable color transformation for computing tristimulus values.

Any color generated by a display such as display 14 may therefore be represented by a point (e.g., by chromaticity values x and y) on a chromaticity diagram such as the diagram shown in FIG. 9. Bounded region 50 of FIG. 9 represents the chromaticity values of all combinations of colors (i.e., the total available color space).

Saturated colors may be included in a subregion such as subregion 50S of bounded region 50. Subregion 50S may included saturated primary colors (e.g., saturated red, saturated green, and saturated blue) and saturated secondary colors (e.g., saturated cyan, saturated magenta, and saturated yellow). Subregion 50N may include neutral colors. Neutral colors may include, for example, colors having equal intensities of red, blue, and green such as white and gray (e.g., different shades of gray).

A third subregion such as subregion 50M may include mid-tone colors. Mid-tone colors in subregion 50M may lie between the saturated colors of region 50S and the neutral colors of region 50N. The human eye may be more sensitive to non-uniformity in mid-tone colors in a display than to non-uniformity in saturated colors. If desired, correction factors may be calculated for a set of representative colors that lie in regions 50M and 50N to reduce color non-uniformity in a display. In general, correction factors may be calculated for any suitable color or set of colors. Choosing a set of colors that lie in regions 50M and 50N is merely illustrative.

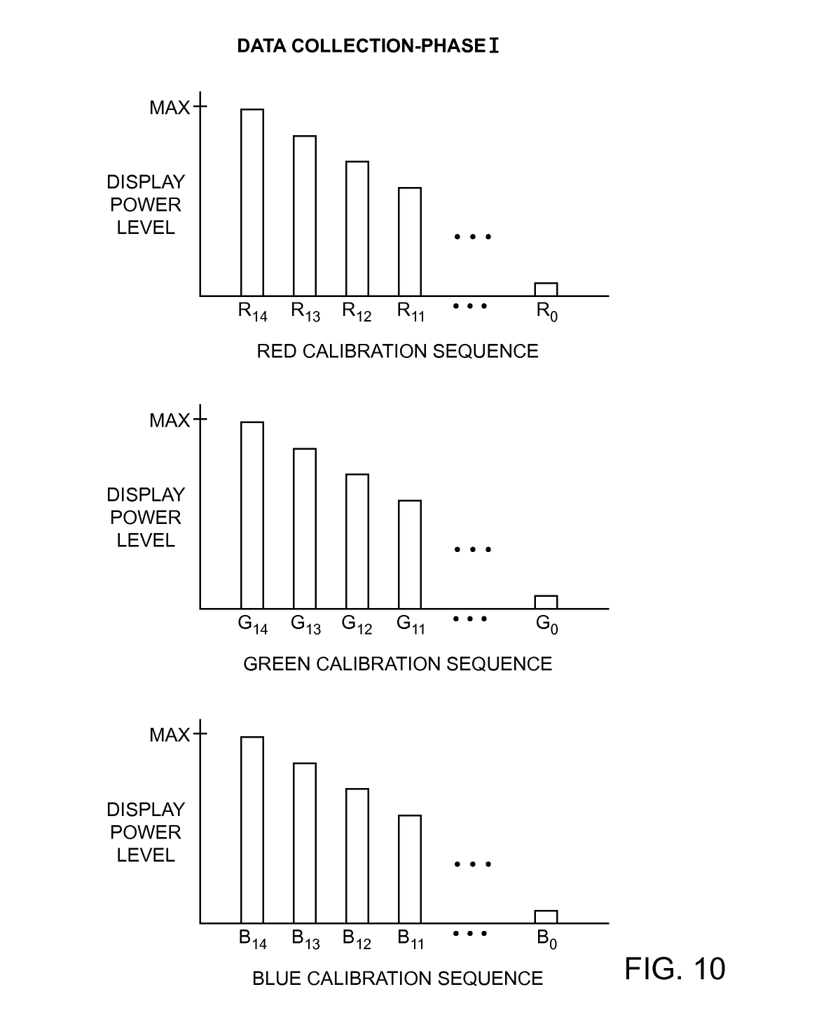

FIG. 10 is a diagram showing an illustrative series of calibration sequences in which display 14 may be operated during a first data collection phase of calibration operations (“DATA COLLECTION—PHASE I”). The first data collection phase may include, for example, a red calibration sequence, a green calibration sequence, and a blue calibration sequence.

As shown in FIG. 10, each calibration sequence may include a series of measurements taken at different power levels while operating the display in a given mode of operation. For example, a red calibration sequence may include operating red pixels at different power levels (e.g., 15 different power levels) while green and blue pixels are turned off. A measurement may be taken at each power level. For example, R₁₄ may correspond to a measurement taken while red pixels are operated at a maximum power level (e.g., while digital display control values of R=255, G=0, and B=0 are supplied to subpixels 35 of display 14), R₁₃ may correspond to a measurement taken while red pixels are operated at a reduced power level (e.g., while digital display control values of R=238, G=0, and B=0 are supplied to subpixels 35 of display 14), R₁₂ may correspond to a measurement taken while red pixels are operated at a further reduced power level (e.g., while digital display control values of R=221, G=0, and B=0 are supplied to subpixels 35 of display 14), R; may correspond to a measurement taken while red pixels are operated at a minimum power level while still being powered on (e.g., while digital display control values of R=17, G=0, and B=0 are supplied to subpixels 35 of display 14), etc. A similar set of measurements may be taken during a green calibration sequence (e.g., measurements G₁₄, G₁₃, G₁₂, . . . , B₀ may be taken during a green calibration sequence) and during a blue calibration sequence (e.g., measurements B₁₄, B₁₃, B₁₂, . . . , B₀ may be taken during a blue calibration sequence).

The example of FIG. 10 in which each calibration sequence includes operating pixels at fifteen different power levels is merely illustrative. If desired, a calibration sequence may include operating pixels at only one power level (e.g., a maximum power level), at five different power levels, at ten different power levels, at seventeen different power levels, at more than seventeen different power levels, at less than seventeen different power levels, etc.

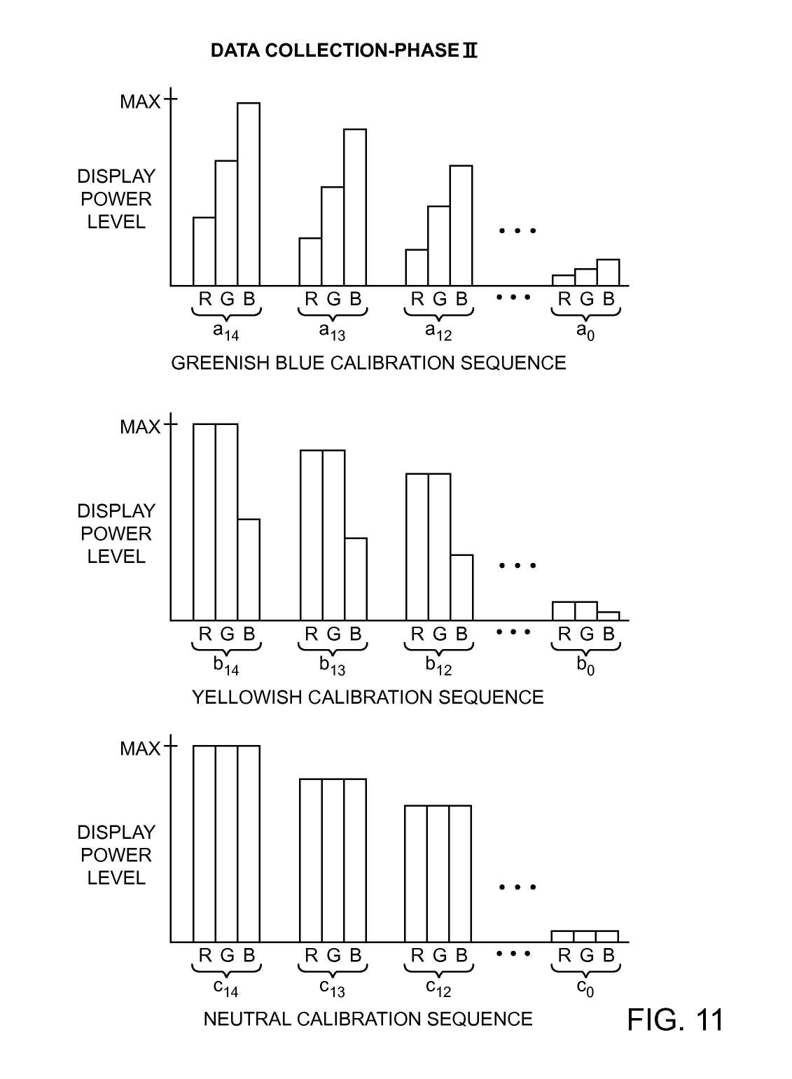

FIG. 11 is a diagram showing an illustrative series of calibration sequences in which display 14 may be operated during a second data collection phase of calibration operations “DATA COLLECTION—PHASE IT”). Each calibration sequence in the second data collection phase may correspond to a representative color for which correction factors are to be calculated. For example, as shown in FIG. 11, the series of calibration sequences may include a greenish blue calibration sequence, a yellowish calibration sequence, a neutral calibration sequence, etc. The colors for which correction factors are to be calculated may determine which calibration sequences are included in the second data collection phase of calibration operations. Correction factors may be calculated for any suitable color. If desired, correction factors may be calculated for a representative set of colors that lie in regions 50M and 50B of FIG. 9. The examples shown in FIG. 11 are merely illustrative. For simplicity, only three calibration sequences of the second data collection phase are shown in FIG. 11. In general, any suitable number of colors may be included in the second data collection phase of calibration operations.

As shown in FIG. 11, each calibration sequence may include a series of measurements taken at different power levels while operating the display in a given mode of operation. For example, a greenish blue calibration sequence may include operating red, green, and blue pixels at different power levels (e.g., 15 different power levels) while maintaining the combination of relative brightness ratios corresponding to bluish green (e.g., while maintaining red pixels at 50% the intensity of green pixels, while maintaining green pixels at 66% the intensity of blue pixels, and while maintaining red pixels at 33% the intensity of blue pixels). A measurement may be taken at each power level. For example, a₁₄ may correspond to a measurement taken while the display is operated at a maximum power level of greenish blue (e.g., while digital display control values of R=85, G=170, and B=255 are supplied to subpixels 35 of display 14), a₁₃ may correspond to a reduced power level of greenish blue, etc.

A similar series of measurements may be taken during each calibration sequence in the second data collection phase (e.g., for each color for which correction factors are to be calculated). In the illustrative graphs shown in FIG. 11, measurements b₁₄, b₁₃, b₁₂, . . . , b₀ correspond to measurements taken during a yellowish calibration sequence, and measurements c₁₄, c₁₃, c₁₂, . . . , c₀ correspond to measurements taken during a neutral calibration sequence.

The data collected during calibration operations may be used to calculate color-specific, intensity-specific, location-specific correction factors. In order to illustrate how the correction factors may be calculated, an example will be described in which correction factors are calculated for a particular color, at a particular intensity level, and at a particular location on a display.

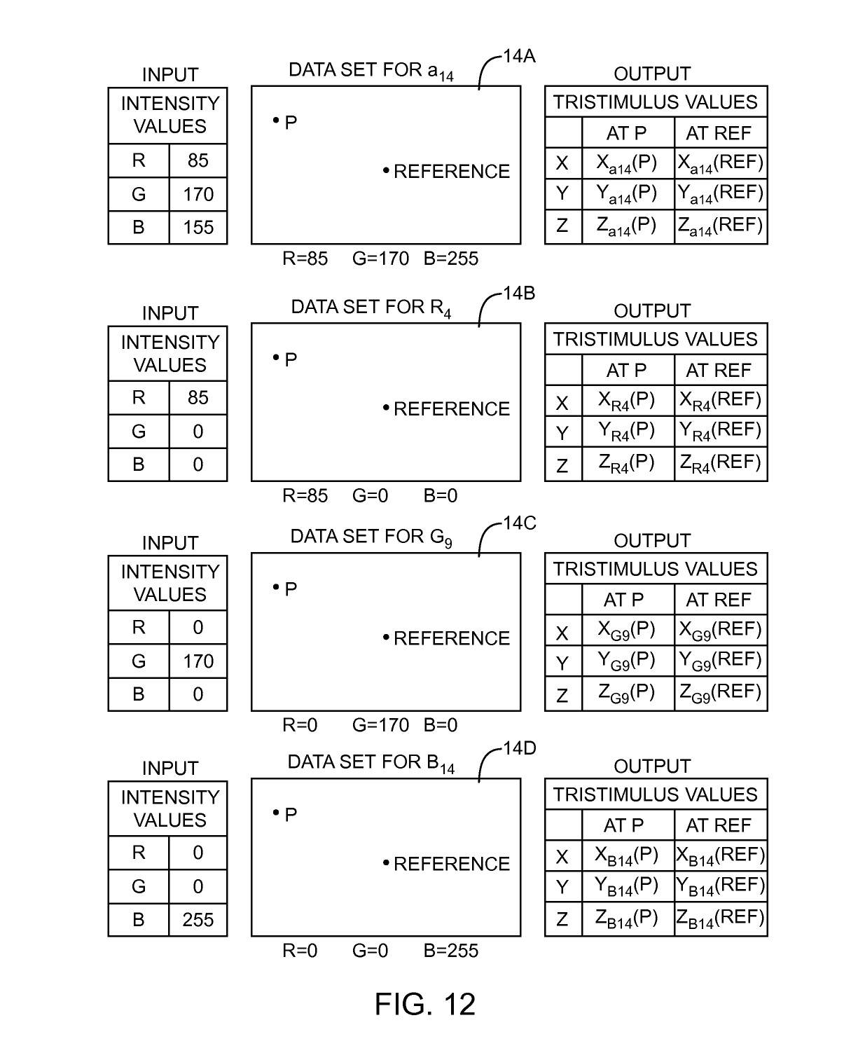

FIG. 12 shows illustrative display performance information that may be used to calculate correction factors for greenish blue, at maximum intensity, at a location such as location “P” on display 14. Correction factors for each color, intensity level, and location may be calculated using the measurements obtained during calibration operations (e.g., during the first and second data collection phases of FIGS. 10 and 11). Each “measurement” may include a captured image of display 14. The measurements that may be used in calculating correction factors for greenish blue, at maximum intensity, at location P are shown in FIG. 12.

The first measurement includes captured image 14A of display 14. Captured image 14A may correspond to measurement a_of FIG. 11. In general, captured image 14A may be a measurement taken during the second data collection phase that corresponds to the color and intensity level for which correction factors are being calculated. In the current example, correction factors are being calculated for bluish green at maximum intensity. Thus, measurement a14 from the bluish green calibration sequence corresponding to a maximum power level of greenish blue (e.g., corresponding to digital display control values of R=85, G=170, and B=255) is used.

The second, third, and fourth measurements shown in FIG. 12 may correspond respectively to measurements R4, G9, and B14 of FIG. 10. Measurement R4 includes captured image 14B of display 14 and may be taken while digital display control values of R=85, G=0, and B=0 are supplied to subpixels 35 of display 14. In general, captured image 14B may be a measurement taken during the red calibration sequence that corresponds to the intensity level of red in the color for which correction factors are being calculated.

In the current example, bluish green at maximum intensity includes a red intensity level of 33% maximum intensity (e.g., corresponding to a digital display control value of R=85).

Measurement G9 includes captured image 14C of display 14 and may be taken while digital display control values of R=0, G=170, and B=0 are supplied to subpixels 35 of display 14. In general, captured image 14C may be a measurement taken during the green calibration sequence that corresponds to the intensity level of green in the color for which correction factors are being calculated. In the current example, bluish green at maximum intensity includes a green intensity level of 66% maximum intensity (e.g., corresponding to a digital display control value of G=170).

Measurement 814 includes captured image 14D of display 14 and may be taken while digital display control values of R=0, G=0, and B=255 are supplied to subpixels 35 of display 14. In general, captured image 14D may be a measurement taken during the blue calibration sequence that corresponds to the intensity level of blue in the color for which correction factors are being calculated. In the current example, bluish green at maximum intensity includes a blue intensity level of 100% maximum intensity (e.g., corresponding to a digital display control value of B=255).

Each measurement may yield an associated set of output data. The output data may include, for example, measured intensities of red light (R), measured intensities of green light (G), and measured intensities of blue light (B). A set of R, G, and B intensity values may be measured at any suitable location on display 14. For example, a set of R, G, and B intensity values may be measured at each predetermined location on display 14 for which correction factors are to be calculated. The measured R, G, and B intensity values associated with each predetermined location may be transformed into X, Y, and Z tristimulus values using a known transformation matrix (e.g., as described above in connection with FIG. 9). The X, Y, and Z tristimulus values that are computed based on measured R, G, and B intensity values may sometimes be referred to herein as “measured” tristimulus values. The measured tristimulus values associated with a given location on the display may sometimes be referred to herein as the measured “color data” associated with that location.

To calculate correction factors for a location such as location “P” on display 14, measured color data associated with location P may be compared with reference color data. Reference color data may, for example, be a measured set of X, Y, and Z tristimulus values or may be a predetermined set of X, Y, and Z tristimulus values. In the case where the reference color data is predetermined, a set of known X, Y, and Z tristimulus values associated with the color for which correction factors are being calculated may be used as reference color data. For example, if correction factors are calculated for white, reference color data may include X, Y, and Z tristimulus values corresponding to the standard illuminant D65 defined by the International Commission on Illumination (CIE).

In the case where reference color data includes a measured set of X, Y, and Z tristimulus values, the reference color data may be measured at a reference location on display 14 (e.g., a location on the display for which display performance information is known, a location on the display at which colors exhibit little to no non-uniformity, a location at the center of the display, etc.). In the current example, reference color data for greenish blue at maximum intensity may include measured X, Y, and Z tristimulus values at a predetermined reference location on display 14.

Measured color data at location P may be compared with measured color data at the reference location. As shown in FIG. 12, measured color data associated with location P may include components Xₐ₁₄(P), Yₐ₁₄(P), and Zₐ₁₄(P) at location P on captured image 14A, components X_{R4}(P), Y_{R4}(P), and Z_{R4}(P) at location P on captured image 14B, components X_{G9}(P), Y_{G9}(P), and Z_{G9}(P) at location P on captured image 14C, and components X_{B14}(P), Y_{B14}(P), and Z_{B14}(P) at location P on captured image 14D. Reference color data may include components Xₐ₁₄(REF), Yₐ₁₄(REF), and Zₐ₁₄(REF) at the reference location on captured image 14A, components X_{R4} (REF), Y_{R4}(REF), and Z_{R4}(REF) at the reference location on captured image 14B, components X_{G9}(REF), Y_{G9}(REF), and Z_{G9}(REF) at the reference location on captured image 14C, and components X_{B14} (REF), Y_{B14}(REF), and Z_{B14} (REF) at the reference location on captured image 14D.

To compare measured color data at location P with reference color data, the X, Y, and Z components from captured images 14B, 14C, and 14D may be respectively added together. For example, the X component associated with location P on captured image 14B, the X component associated with location P on captured image 14C, and the X component associated with location P on captured image 14D may be added together to obtain X_{P}. More specifically, the following summations may be made:

X_{R4}(P)+X_{G9}(P)+X_{B14}(P)=X_{P} (1)

Y_{R4}(P)+Y_{G9}(P)+Y_{B14}(P)=Y_{P} (2)

Z_{R4}(P)+Z_{G9}(P)+Z_{B14}(P)=Z_{P} (3)

X_{R4}(REF)+X_{G9}(REF)+X_{B14}(REF)=X_{REF} (4)

Y_{R4}(RFF)+Y_{G9}(REF)+Y_{B14}(REF)=Y_{REF} (5)

Z_{R4}(REF)+Z_{G9}(REF)+Z_{B14}(REF)=Z_{REF} (6)

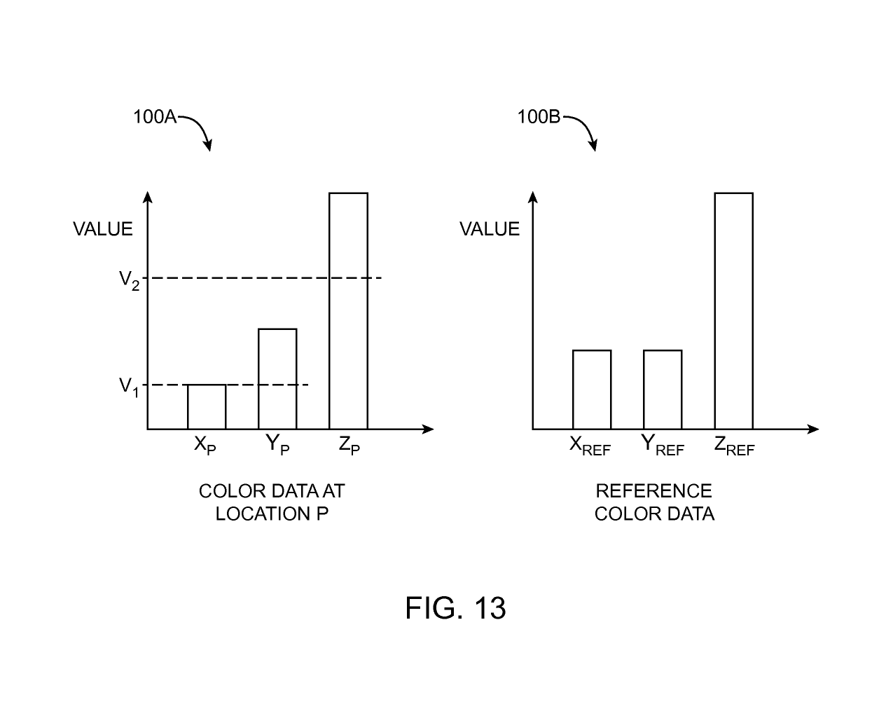

The measured color data at location P may therefore be represented by the components X_{P}, Y_{P}, and Z_{P}, and the reference color data at the reference location may be represented by the components X_{REF}, Y_{REF}, and Z_{REF}. Illustrative graphs of color data at location P and reference color data are shown in FIG. 13. As shown in graph 100A, color data at location P may include components X_{P}, Y_{P}, and Z_{P}. As shown in graph 100B, reference color data may include components X_{REF}, Y_{REF}, and Z_{REF}. Reference color data of graph 100B may be measured (e.g., calculated from measured values as described above) or may be a predetermined set of tristimulus values associated with the color and intensity for which correction factors are being calculated.

Color data at location P may be compared with reference color data. In particular, the relative ratios of components X_{REF}, Y_{REF}, and Z_{REF} may be compared with the relative ratios of components X_{P}, Y_{P}, and Z_{P}. In the illustrative example shown in FIG. 13, the ratio of X_{REF} to Y_{REF} is 1:1, the ratio of Y_{REF} to Z_{REF} is 1:3, and the ratio of X_{REF} to Z_{REF} is 1:3. In comparison, the ratio of X_{P} to Y_{P} may be 1:2, the ratio of Y_{P} to Z_{P} may be 1:2, and the ratio of X_{P} to Z_{P} may be 1:4.

A set of factors fₓ, f_{y}, and f_{z} may be calculated based on the comparison between measured color data at location P and reference color data (e.g., measured color data at the reference location). The set of factors may be a set of numbers which are each less than or equal to one and may be calculated such that, when X_{P}, Y_{P}, and Z_{P}, are multiplied respectively by factors fₓ, f_{y}, and f_{z}, the resulting ratios of X, Y, and Z components at location P is equivalent or substantially equivalent to the ratios of X_{REF}, Y_{REF}, and Z_{REF}. This method is based on the fact that if the ratios of X, Y, and Z components of one color are equivalent to those of another color, then the colors must be the same.

In the illustrative example of FIG. 13, factors fₓ, f_{y}, and f_{z} may be calculated such that, when multiplied respectively with X_{P}, Y_{P}, and Z_{P} the resulting ratio of X to Y at location P is 1:1, the resulting ratio of Y to Z at location P is 1:3, and the resulting ratio of X to Z at location P is 1:3. If desired, one or more boundary conditions may be defined. For example, to preserve a maximum of brightness in the display, a boundary condition that requires at least one of factors fₓ, f_{y}, and f_{z} to be equal to one may be imposed.

In the illustrative example of FIG. 13, a set of factors that satisfies this boundary condition while also producing X, Y, and Z components with ratios that match those of X_{REF}, Y_{REF}, and Z_{REF} a may include, for example, fₓ=1, f_{y}=0.5, and f_{z}=0.75. When X is multiplied by fₓ, X_{P} will remain at value V₁. When Y_{P} is multiplied by f_{y}, Y_{P} will be reduced to value V₁. When Z_{P} is multiplied by fₓ, Z_{P} will be reduced to value V₁. Thus, the resulting ratio of X to Y at location P will be 1:1, the resulting ratio of Y to Z at location P will be 1:3, and the resulting ratio of X to Z at location P will be 1:3, thereby matching the set of ratios associated with reference color data.

The calculated set of factors fₓ, f_{y}, and f_{z} may be used to calculate target X, Y, and Z values. Target X, Y, and Z values may be calculated by multiplying factors fₓ, f_{y}, and f_{z} respectively with the measured X, Y, and Z values at location P on captured image 14A of FIG. 12. More specifically, the following equations may be used to calculate target components X_{TARGET}, Y_{TARGET}, and Z_{TARGET}:

X_{TARGET}=Xₐ₁₄(P)*fₓ (7)

Y_{TARGET}=Yₐ₁₄(P)*f_{y} (8)

Z_{TARGET}=Zₐ₁₄(P)*f_{z} (9)

The target components X_{TARGET}, Y_{TARGET}, and Z_{TARGET} may be used to calculate color-specific, intensity-specific, location-specific correction factors f_{R}, f_{G}, and f_{B}. To calculate the correction factors, the following equation may be used:

$$\begin{matrix}[ \begin{matrix}{f}_{R} \\ {f}_{G} \\ {f}_{B}\end{matrix} ] = {M}_{3 \text{/} 3}^{- 1} * [ \begin{matrix}{X}_{TARGET} \\ {Y}_{TARGET} \\ {Z}_{TARGET}\end{matrix} ] & ( 10 )\end{matrix}$$

where M_{3×3}⁻¹ is the inverse of a three by three matrix M_{3×3}. Matrix M_{3×3} may be composed of measured X, Y, and Z tristimulus values from red, green and blue calibration sequences. In particular, M_{3×3} may be of the following form:

$${M}_{3 \text{/} 3} = [ \begin{matrix}{X}_{red} & {X}_{green} & {X}_{blue} \\ {Y}_{red} & {Y}_{green} & {Y}_{blue} \\ {Z}_{red} & {Z}_{green} & {Z}_{blue}\end{matrix} ] \qquad ( 11 )$$

where the first column includes values X_{red}, Y_{red}, and Z_{red}; associated with a given measurement in the red calibration sequence, the second column includes values X_{green}, Y_{green}, and Z_{green} associated with a given measurement in the green calibration sequence, and the third column includes values X_{blue}, Y_{blue}, and Z_{blue} associated with a given measurement in the blue calibration sequence. The first, second, and third columns may therefore respectively correspond to a measured intensity level R of red light, a measured intensity level G of green light, and a measured intensity level B of blue light.

The X, Y, and Z values that populate matrix M_{3×3} may be chosen in any suitable manner. In one suitable embodiment, the values may be chosen such that the columns all correspond to the same intensity level (e.g., such that R=G=B). The intensity level may be based on the color and intensity for which correction factors are being calculated. For example, the R, G, and B intensity values represented by the columns of matrix M_{3×3} may be chosen such that they are close in value respectively to the R, G, and B intensity values of the color and intensity level for which correction factors are being calculated (while still maintaining color neutrality such that R=G=B). The intensity of light represented by the columns of matrix M_{3×3} may, for example, be an average of the R, G, and B values associated with the color and intensity level for which correction factors are being calculated. In the current example, correction factors are being calculated for greenish blue at maximum intensity having R, G, and B intensity values of 85, 170, and 255, respectively. The intensity of light represented by the columns of matrix M_{3×3} may, for example, be the average of values 85, 170, and 255. The resulting average intensity value of 170 corresponds to measurement R9 in the red calibration sequence, G9 in the green calibration sequence, and B9 in the blue calibration sequence. The corresponding matrix M_{3×3} would then be the following:

$${M}_{3 \text{/} 3} = [ \begin{matrix}{X}_{R 9} & {X}_{G 9} & {X}_{B 9} \\ {Y}_{R 9} & {Y}_{G 9} & {Y}_{B 9} \\ {Z}_{R 9} & {Z}_{G 9} & {Z}_{B 9}\end{matrix} ] \qquad ( 12 )$$

where the first column includes values X_{R9}, Y_{R9}, and Z_{R9} associated with the R=170 measurement in the red calibration sequence, the second column includes values X_{G9}, Y_{G9}, and Z_{G9} associated with the G=170 measurement in the green calibration sequence, and the third column includes values X_{B9}, Y_{B9}, and Z_{B9} associated with the B=170 measurement in the blue calibration sequence.

In general, matrix M_{3×3} may be populated in any suitable manner. The example in which the R, G, and B intensity values represented by the columns of matrix M_{3×3} are chosen such that they are close in value respectively to the R, G, and B intensity values of the color and intensity level for which correction factors are being calculated is merely illustrative.

The inverse matrix M_{3×3} may be computed from matrix M_{3×3} and may be used in equation (10) to calculate color-specific, intensity-specific, location-specific correction factors f_{R}, f_{G}, and f_{B}. In the current example, the correction factors calculated using equation (10) would correspond to greenish blue, at maximum intensity, at location P.

Correction factors may be calculated for any suitable color, may be calculated for any suitable intensity level, and may be calculated for any suitable location on display 14. The calculation described above in which correction factors are computed for greenish blue, at maximum intensity, at location P is merely illustrative and may be applied similarly to any suitable combination of color, intensity level, and location.

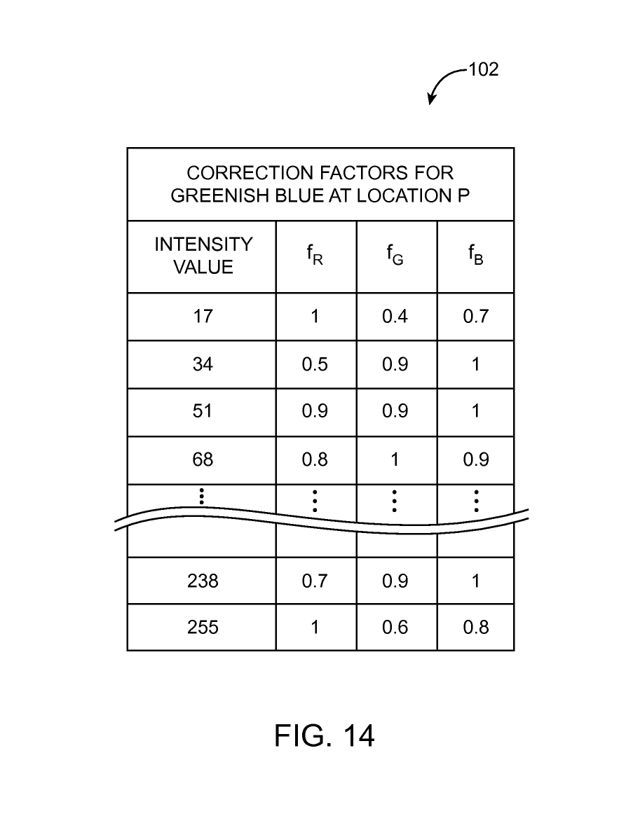

If desired, the correction factors calculated during calibration operations may be stored in a look-up table. An illustrative table of correction factors for greenish blue at location P is shown in FIG. 14. As shown in FIG. 14, table 102 includes a first column corresponding to different intensity values for which correction factors have been calculated. The second, third, and fourth columns of table 102 correspond respectively to correction factors f_{R} for red, correction factors f_{G} for green, and correction factors f_{B} for blue. Because of the boundary condition which was applied during calculation of the correction factors, the set of correction factors corresponding to each intensity value may have at least one factor equal to one. This may ensure that the application of correction factors during operation of the display does not negatively affect the overall brightness of the display.

A table such as table 102 of FIG. 14 may be generated for each color and location for which correction factors are calculated. For example, if there are 9 colors and 100 locations on display 14 for which correction factors are to be calculated, then there will be a total of 900 tables (i.e., 100 tables per color). If correction factors are calculated for 15 different shades of each color (as an example), then each table will have 15 sets of correction factors corresponding to 15 different intensity values. This is, however, merely illustrative. In general, correction factors may be calculated for any suitable number of colors, intensity values, and locations on display 14.

Tables such as table 102 of FIG. 14 may be stored in device 10. For example, tables such as table 102 if FIG. 14 may be stored in storage and processing circuitry 30, graphics controller 52, or display driver circuitry 28 (FIG. 5). During operation of display 14, incoming subpixel values R, G, and B that are supplied to each pixel in display 14 may be multiplied respectively by correction factors f_{R}, f_{G}, and f_{B} to generate adapted pixel values R′, G′, and B′.

The correction factors which are applied to a given pixel may depend on the color to be displayed by that pixel, the intensity level of light to be displayed by that pixel, and the location of that pixel on the display. Based on this information, a set of correction factors f_{R}, f_{G}, and f_{B} may be determined.

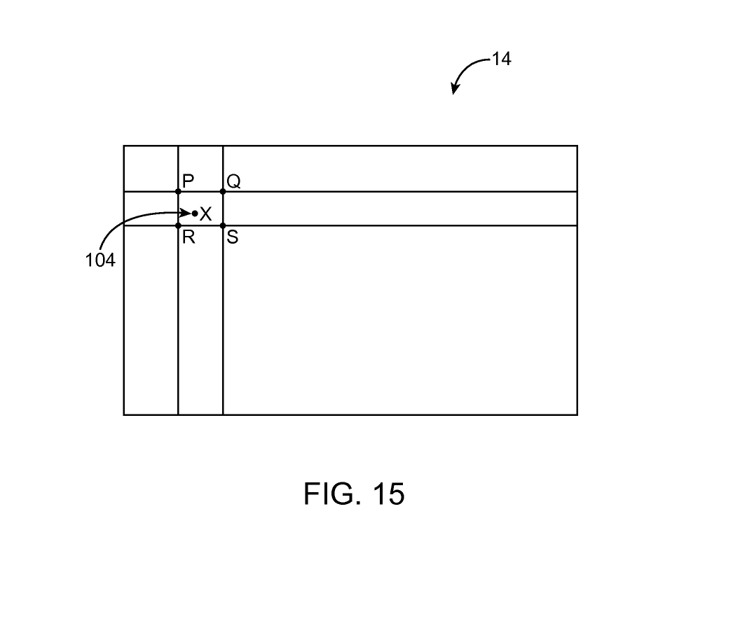

Consider, for example, a pixel such as pixel 104 of FIG. 15. Pixel 104 may be located at location X on display 14. Pixel 104 at location X may include, for example, red, green, and blue subpixels. During operation of display 14, storage and processing circuitry 30 (FIG. 5) may supply to display 14 an incoming set of R, G, and B values for pixel 104. The incoming R, G, and B values may be received by display control circuitry 68 (e.g., by a TCON integrated circuit in circuitry 28). Based on the received information, display control circuitry 68 may determine the color to be displayed by pixel 104, the intensity of light to be displayed by pixel 104, and the location of pixel 104. Display control circuitry 68 may determine a set of correction factors which most closely corresponds to that particular color, intensity, and location. The set of correction factors may be applied to the incoming subpixel values to generate adapted subpixel values, which may in turn be supplied to subpixels 35 of pixel 104.

It may be the case that correction factors were not calculated for an exact color, intensity level, and location associated with pixel 104. Techniques such as the least squares method, linear interpolation, bilinear interpolation, and other suitable approximation techniques may be used to determine an optimal set of correction factors for each particular color, intensity level, and location associated with a given pixel.

For example, circuitry 68 may compare the color to be displayed by pixel 104 with the representative colors for which correction factors have been calculated. If desired, the least squares method or any other suitable approximation method may be used to determine which representative color most closely matches the color to be displayed by pixel 104. This may include, for example, comparing the set of brightness ratios associated with incoming R, G, and B values with the sets of brightness ratios associated with the representative colors for which correction factors have been calculated.

After determining the representative color that most closely matches the color to be displayed by pixel 104 (sometimes referred to as the “best match” color), the location of pixel 104 may be taken into account. If location X of pixel 104 is not one of the locations for which correction factors have been calculated, circuitry 68 may determine the nearest locations for which correction factors have been calculated. In the example of FIG. 15, circuitry 68 may determine that neighboring pixel locations P, Q, R, and S are the nearest locations to location X for which correction factors have been calculated. One or more look-up tables (e.g., look-up tables similar to table 102 of FIG. 14) may be associated with each neighboring pixel location. For example, if correction factors were calculated for 9 representative colors, then a set of 9 look-up tables would be associated with each neighboring pixel location.

For each neighboring pixel location, circuitry 68 may obtain a set of correction factors which most closely corresponds to the color and intensity level to be displayed by pixel 104. The sets of correction factors may be obtained from the look-up tables associated with the best match color and the neighboring pixel locations. For example, if greenish blue is determined to be the best match color for pixel 104, then correction factors may be obtained from the greenish blue look-up tables associated respectively with locations P, Q, R, and S.

Obtaining a set of correction factors from each look-up table may include, for example, choosing the set of correction factors corresponding to an intensity level that most closely matches the intensity to be displayed by pixel 104. As another example, if the intensity to be displayed by pixel 104 falls between two intensity levels for which correction factors have been calculated, linear interpolation may be used to calculate a set of correction factors. This is, however, merely illustrative. In general, any suitable approximation method may be used to determine an optimal set of correction factors when correction factors corresponding to the exact intensity of light to be displayed by pixel 104 have not been stored in device 10.

Once circuitry 68 has obtained a set of correction factors for each neighboring pixel location, circuitry 68 may then determine a final set of correction factors f_{B}, f_{G}, and f_{B} to apply to the incoming subpixel values for pixel 104. This may include, for example, using bilinear interpolation to calculate a set of correction factors for pixel 104 based on the correction factors obtained from neighboring pixel locations P, Q, R, and S. This is, however, merely illustrative. If desired, other approximation methods may be used to determine a set of correction factors for pixel 104 based on the correction factors obtained from neighboring pixel locations.

Circuitry 68 may apply the final set of correction factors f_{R}, f_{G}, and f_{B} to incoming subpixel values to obtain adapted subpixel values R′, G′, and B′. Circuitry 68 may supply the adapted pixel values to pixel 104 on display 14 (e.g., via path 66 of FIG. 5).

The procedure of pixel adaptation just described 10 may take place for each pixel in display 14 or may, if desired, take place for a selected group of pixels in display 14. Pixel adaptation may take place continuously during operation of display 14 or may, if desired, take place at intervals during operation of display 14.

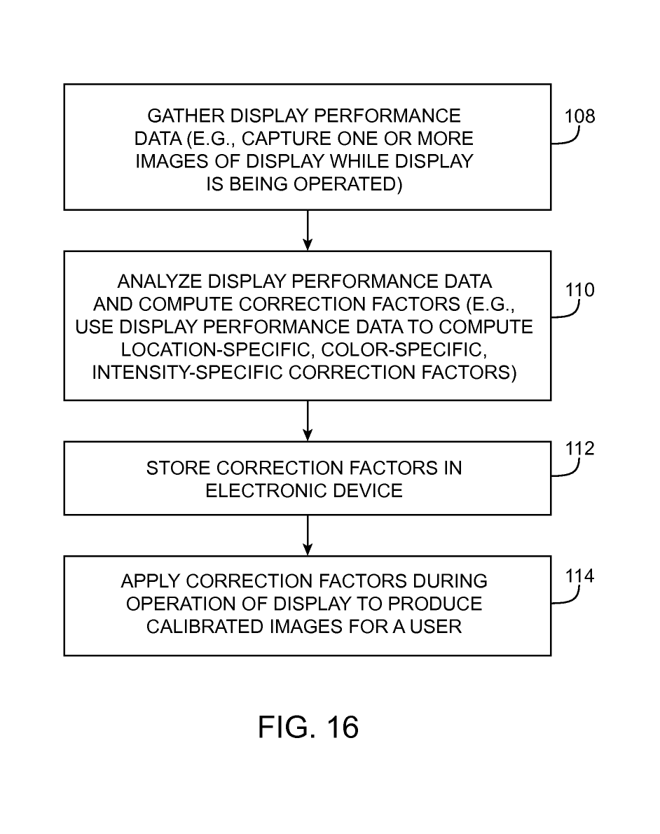

FIG. 16 is a flow chart of illustrative steps involved in calibrating a display such as display 14.

At step 108, a calibration system such as calibration system 48 of FIG. 8 may be used to gather display performance data from display 14. For example, light sensor 40 may be used to gather one or more images of display 14 while display 14 is operated in a series of calibration sequences. This may include, for example, capturing images of display 14 while pixels 34 are operated at different intensity levels.

At step 110, the display performance data gathered by calibration computing equipment 46 may be processed and analyzed. Processing may include, for example, reducing the resolution (e.g., radiometric resolution) of each captured image of display 14 based on the areas of display 14 that exhibit greater color non-uniformity. Once processed, the display performance data may be used to compute color-specific, intensity-specific, location-specific correction factors. Computation of correction factors may be performed during manufacturing operations or may be performed during operation of display 14. For example, display performance data may be stored on electronic device 10 and correction factors may be calculated locally on device 10 during operation of display 14. If correction factors are computed during manufacturing operations, such computations may be performed by calibration computing equipment 46 or may be performed by computing equipment that is separate from calibration system 48.

At step 112, the correction factors calculated during step 110 may be stored in device 10. This may include, for example, storing look-up tables such as look-up table 102 of FIG. 14 in electronic device 10. If desired, correction factors may be stored in display control circuitry 68 or may be stored in any other suitable location in device 10. If correction factors are calculated during operation of display 14, step 112 may be omitted.

At step 114, correction factors may be applied to incoming subpixel values during operation of display 14. For example, display control circuitry 68 may receive incoming subpixel values from storage and processing circuitry 30 in device 10 and may, based on the received incoming subpixel values, calculate and apply correction factors to the incoming subpixel values to obtain adapted subpixel values. The adapted incoming subpixel values may subsequently be supplied to subpixels 35 of display 14 to produce calibrated images for a user.

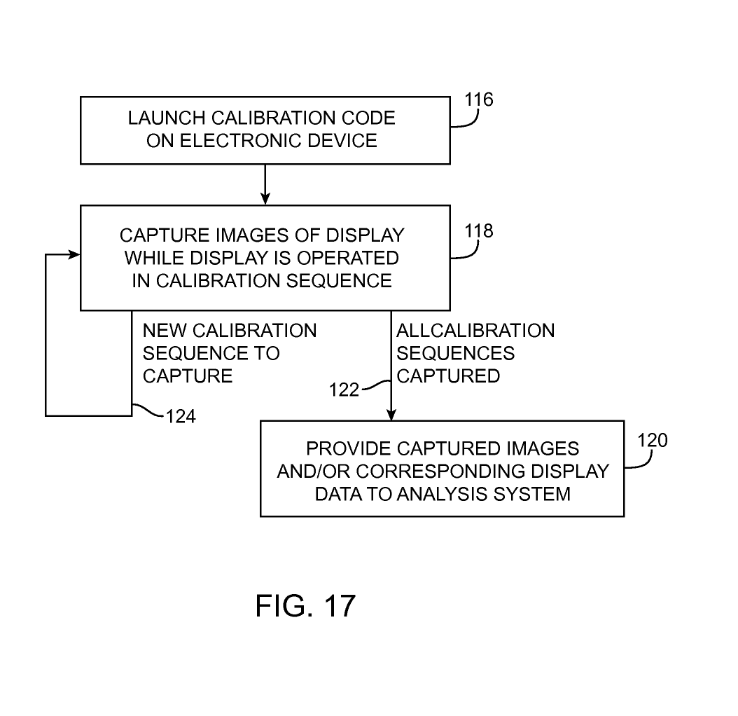

FIG. 17 is a flow chart of illustrative steps involved in gathering display performance data (e.g., during step 108 of FIG. 16).

At step 116, calibration code may be launched on electronic device 10. This may include, for example, launching calibration code on device 10 after placing device 10 in a test chamber such as test chamber 38 of FIG. 8. Calibration code on device 10 may be used to operate device 10 in a series of calibration sequences while display performance data is gathered.

At step 118, light sensor 40 may capture images of display 14 while display 14 is operated in a calibration sequence. For example, a red calibration sequence may include capturing a series of images of display 14 while the red pixels of display 14 are operated at different power levels (e.g., with green and blue pixels turned off). Each captured image may include information about the performance of display 14. For example, display performance information such as X, Y, and Z tristimulus values may be obtained from each captured image in a given calibration sequence.

If more calibration sequences are to be captured, calibration operations may repeat step 118, as indicated by line 124. Device 10 may be operated in any suitable number of calibration sequences. In a first data collection phase, for example, device 10 may be operated in a red calibration sequence, a blue calibration sequence, and a green calibration sequence. In a second data collection phase, device 10 may be operated in a series of calibration sequences corresponding to the colors for which correction factors are calculated (e.g., a series of nine calibration sequences corresponding to nine representative colors).

After all calibration sequences have been captured, calibration operations may proceed to step 120, as indicated by line 122. At step 120, the images captured during step 118 and/or the display performance data corresponding to such images may be provided to an analysis system for analysis. If correction factors are calculated during manufacturing, the analysis system may include calibration computing equipment 46. With this type of configuration, calibration computing equipment 46 may process and analyze the captured images and corresponding display performance data to calculate color-specific, intensity-specific, location-specific correction factors. If correction factors are calculated during operation of display 14, the analysis system may be formed as part of electronic device 10. With this type of configuration, display performance data gathered during step 118 may be stored on device 10 and may be used to calculate color-specific, intensity-specific, location-specific correction factors during operation of display 14.

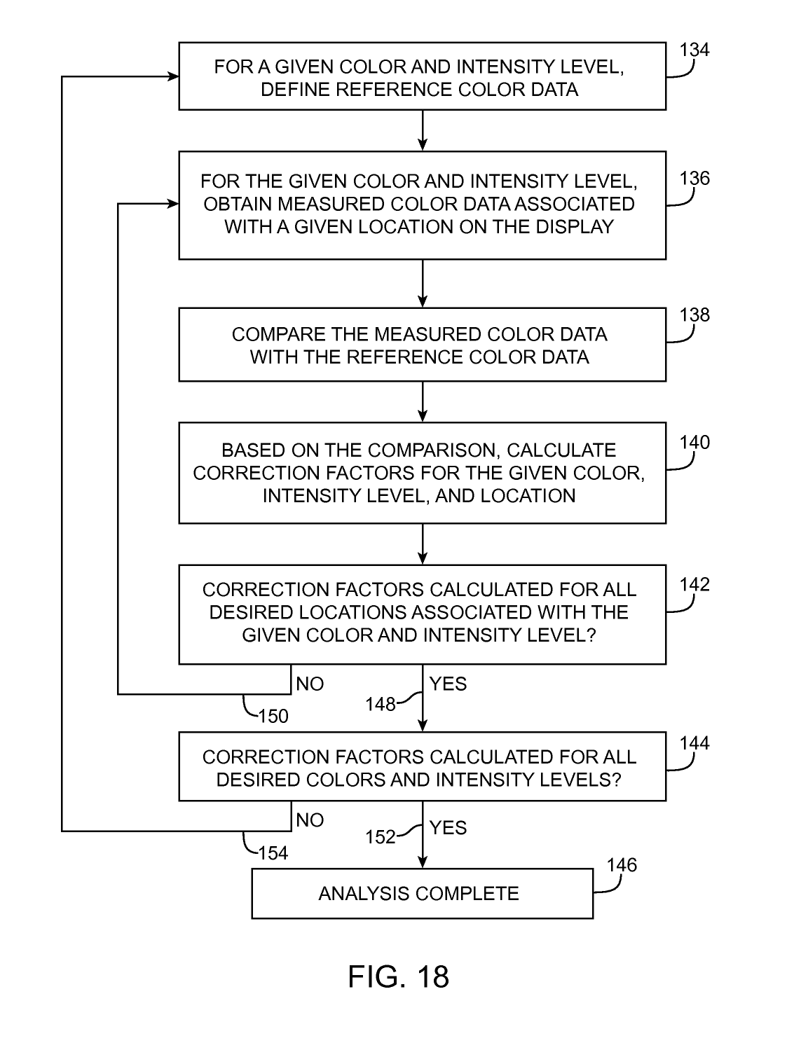

FIG. 18 is a flow cart of illustrative steps involved in using computing equipment such as calibration computing equipment 46 to calculate color-specific, intensity-specific, location-specific correction factors.

At step 134, reference color data may be defined for the color and intensity level for which correction factors are being calculated. In one suitable embodiment, reference color data may include predetermined X, Y, and Z tristimulus values (e.g., a set of X, Y, and Z values defined by the International Commission on Illumination or other predetermined set of tristimulus values). In another suitable embodiment, reference color data may include measured color data at a reference location on display 14 (e.g., a set of X, Y, and Z tristimulus values measured at a reference location on display 14). Calibration computing equipment 46 may obtain reference color data from the images captured during calibration operations (FIG. 17). Reference color data may be specific to the color and intensity level for which correction factors are being calculated. Equations similar to equations (4) through (6) may be used during step 136 to obtain reference color data (e.g., measured reference color data).

At step 136, calibration computing equipment 46 may obtain measured color data for a location on the display for which correction factors are being calculated. Measured color data may include, for example, measured X, Y, and Z tristimulus values associated with the color, intensity level, and location for which correction factors are being calculated and may be obtained from the images captured during calibration operations (FIG. 17). Equations similar to equations (1) through (3) may be used during step 136 to obtain measured color data (e.g., measured color data associated with a location such as location P).

At step 138, calibration computing equipment 46 may compare measured color data with reference color data (FIG. 13). Step 138 may include, for example, comparing relative ratios of measured X, Y, and Z components associated with the color, intensity level, and location for which correction factors are being calculated with the measured X, Y, and Z components associated with the reference location. If reference color data is a predetermined set of tristimulus values, then step 138 may include comparing the predetermined X, Y, and Z components with the measured X, Y, and Z components associated with the color, intensity level, and location for which correction factors are being calculated.

At step 140, calibration computing equipment 46 may calculate correction factors based on the comparison of step 138. For example, calibration computing equipment may use equations (7) through (9) to calculate a set of target X, Y, and Z components based on the comparison of measured X, Y, and Z components with reference X, Y, and Z components. The target X, Y, and Z components may then be transformed into corresponding correction factors f_{R}, f_{G}, and f_{B} using equation (10). The correction factors f_{R}, f_{G}, and f_{B}, may be color-specific, intensity-specific, and location-specific.

At step 142, computing equipment 46 may determine whether or not correction factors have been calculated for all desired locations associated with a given color and intensity level. If correction factors are to be calculated for more locations, processing may return to step 136, as indicated by line 150. If correction factors have been calculated for all locations for a given color and intensity level, processing may proceed to step 144, as indicated by line 148.

At step 144, computing equipment 46 may determine whether or not correction factors have been calculated for all desired colors and intensity levels. If correction factors are to be calculated for more colors and/or more intensity levels of a given color, processing may return to step 134, as indicated by line 154. If correction factors have been calculated for all desired colors and intensity levels, processing may proceed to step 146, as indicated by line 152.

At step 146, analysis is complete and the correction factors calculated by computing equipment 46 may be stored in device 10 (e.g., in the form of look-up tables such as look-up table 102 of FIG. 14).

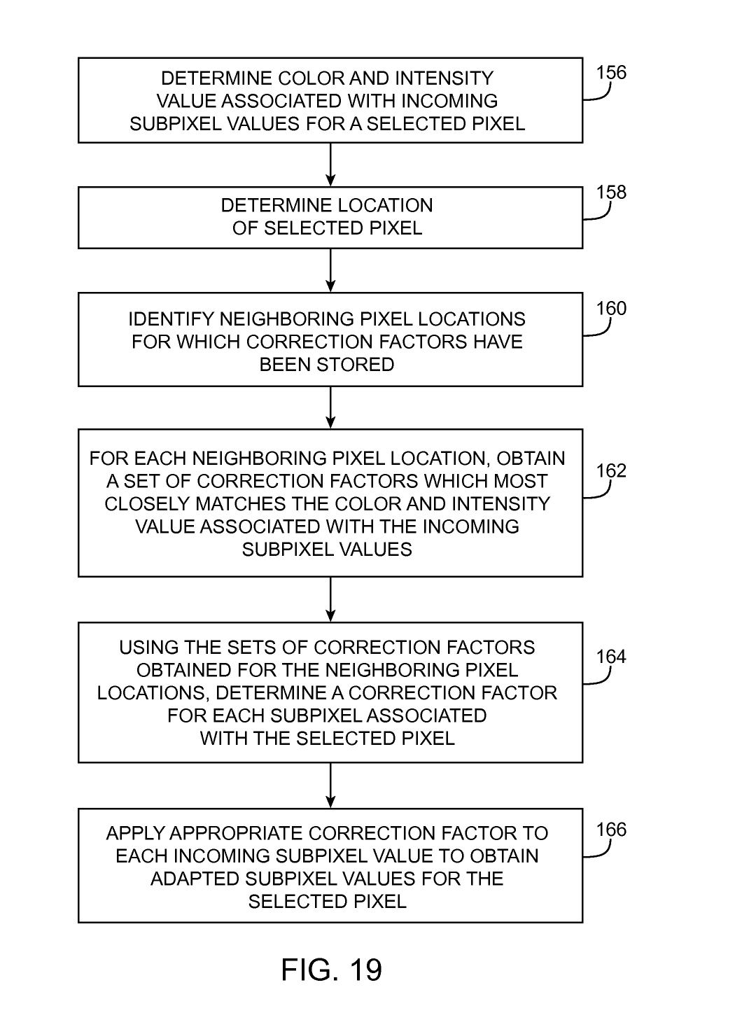

FIG. 19 is a flow chart of illustrative steps involved in performing pixel adaptation during operation of display 14.

At step 156, display control circuitry 68 may receive incoming R, G, and B subpixel values (sometimes referred to as data, display data, digital display control values, or display control signals) for a selected pixel from storage and processing circuitry 30. If desired, display control circuitry 68 may optionally linearize the incoming subpixel values to remove display gamma non-linearity (e.g., if the display gamma is not equal to one). If the display gamma is equal to one, the step of linearizing the incoming subpixel values may be omitted. Based on the linearized incoming subpixel values, display control circuitry 68 may determine the color and intensity level to be displayed by the selected pixel.

At step 158, display control circuitry 68 may determine the location of the selected pixel for which incoming subpixel values have been received (e.g., a location such as location X of FIG. 15).

At step 160, display control circuitry 68 may identify neighboring pixel locations for which correction factors have been stored (e.g., locations P, Q, R, and S of FIG. 15).

At step 162, display control circuitry 68 may obtain a set of correction factors from each of the neighboring pixel locations. Display control circuitry 68 may determine which set of correction factors most closely corresponds to the color and intensity level to be displayed by the selected pixel. For example, if the color to be displayed by the selected pixel most closely matches greenish blue, then a set of correction factors may be obtained from the greenish blue look-up table at each neighboring pixel location. If desired, display control circuitry 68 may use the method of least squares, linear interpolation, or other approximation methods to obtain a set of correction factors that most closely corresponds to the color and intensity to be displayed by the selected pixel. Display control circuitry 68 may obtain a set of correction factors from each neighboring pixel location.

At step 164, display control circuitry 68 may determine a final set of correction factors to be applied to the linearized incoming subpixel values based on the sets of correction factors obtained from the neighboring pixel locations. This may include, for example, using bilinear interpolation to obtain a final set of correction factors f_{R}, f_{G}, and f_{B} based on the sets of correction factors obtained from the neighboring pixel locations.

At step 166, display control circuitry 68 may apply the appropriate correction factor to each linearized incoming subpixel value (e.g., the linearized incoming subpixel value for red may be multiplied by f_{R}, the linearized incoming subpixel value for green may be multiplied by f_{G}, and the linearized incoming subpixel value for blue may be multiplied by f_{B}). The resulting adapted linearized subpixel values may then optionally be de-linearized (e.g., to restore the non-linear display gamma) to obtain adapted subpixel values R′, G′, and B′. The adapted subpixel values may then be supplied to the selected pixel (e.g., via path 66 if FIG. 5).

The pixel adaptation process described in connection with FIG. 19 may be performed for every pixel in display 14 or, if desired, for a selected group of pixels in display 14. The process may be performed continuously during operation of display 14 (e.g., incoming subpixel values may be continuously adjusted to generate adapted subpixel values) or may be performed at intervals during operation of display 14.

The foregoing is merely illustrative of the principles of this invention and various modifications can be made by those skilled in the art without departing from the scope and spirit of the invention. The foregoing embodiments may be implemented individually or in any combination.

What is claimed is:

1. A method for displaying data on a display that has an array of display pixels, wherein the data includes color information and intensity information for each display pixel, wherein each display pixel has a location on the display, and wherein the display has display control circuitry that supplies the data to each of the display pixels, the method comprising:
for each display pixel in the display, using the display control circuitry to:
determine correction factor information to apply to the data for the display pixel based on the color information for the display pixel, the intensity information for the display pixel, and the location of the display pixel;
apply the correction factor information to the data for the display pixel; and
display the data to which the correction factor information has been applied on the display pixel.

2. The method defined in claim 1, wherein the correction factor information includes correction factor values corresponding to a plurality of different display pixel locations in the display, and wherein using the display control circuitry to determine the correction factor information comprises:
with the display control circuitry, using interpolation to determine the correction factor information for at least some of the display pixels based on the correction factor values.

3. The method defined in claim 1, wherein the display pixel comprises a red subpixel, a green subpixel, and a blue subpixel, and wherein using the display control circuitry to determine the correction factor information comprises:
with the display control circuitry, determining a red correction factor for the red subpixel, a green correction factor for the green subpixel, and a blue correction factor for the blue subpixel.

4. The method defined in claim 1, wherein the correction factor information includes correction factor values corresponding to a plurality of different colors and wherein using the display control circuitry to determine the correction factor information comprises:
with the display control circuitry, determining which color in the plurality of different colors corresponds to the color information for each display pixel.

5. The method defined in claim 1, wherein the correction factor information includes correction factor values corresponding to a plurality of different intensity levels and wherein using the display control circuitry to determine the correction factor information comprises:
with the display control circuitry, determining which intensity level in the plurality of different intensity levels corresponds to the intensity information for each display pixel.

6. The method defined in claim 1, wherein using the display control circuitry to determine the correction factor information for the display pixel comprises:
with the display control circuitry, receiving first and second digital display control values,
with the display control circuitry, determining a ratio between the first digital display control value and the second digital display control value; and
with the display control circuitry, using the ratio to determine the correction factor information for the display pixel.

7. A method for obtaining display calibration data for an electronic device having a display, comprising:
with calibration computing equipment, gathering display performance information from the display; and
with the calibration computing equipment, determining a plurality of color-specific, intensity-specific, location-specific correction factors based on the display performance information.

8. The method defined in claim 7, wherein the display performance information includes color information and intensity information measured at a plurality of different locations on the display and wherein determining the plurality of color-specific, intensity-specific, location-specific correction factors based on the display performance information comprises:
with the calibration computing equipment, determining the plurality of color-specific, intensity-specific, location-specific correction factors using the color information and the intensity information measured at the plurality of locations on the display.

9. The method defined in claim 7, wherein gathering display performance information from the display comprises:
with a light sensor, capturing a plurality of images of the display while the display is operated in a plurality of different modes of operation.

10. The method defined in claim 7, wherein determining the plurality of color-specific, intensity-specific, location-specific correction factors comprises:
with the calibration computing equipment, comparing measured color data at a given location on the display with measured color data at a reference location.

11. The method defined in claim 10, wherein the measured color data at the given location on the display comprises a first set of tristimulus values measured at the given location, wherein the measured color data at the reference location on the display comprises a second set of tristimulus values measured at the reference location, and wherein comparing measured color data at the given location on the display with measured color data at the reference location comprises:
comparing the first set of tristimulus values with the second set of tristimulus values.

12. The method defined in claim 7, wherein determining the plurality of color-specific, intensity-specific, location-specific correction factors comprises:
with the calibration computing equipment, comparing measured tristimulus values at a given location on the display with predetermined tristimulus values.

13. A method for displaying images on a display, wherein the display includes an array of display pixels and is controlled by display control circuitry, comprising:
with the display control circuitry, receiving a display control signal for a display pixel in the array of display pixels;
with the display control circuitry, determining a color-specific, intensity-specific, location-specific correction factor based on the received display control signal; and
with the display control circuitry, applying the color-specific, intensity-specific, location-specific correction factor to the display control signal to obtain an adapted display control signal.

14. The method defined in claim 13, further comprising:
with the display control circuitry, providing the adapted display control signal to the display pixel.

15. The method defined in claim 13, further comprising:
with the display control circuitry, determining a color to be displayed by the display pixel based on the received display control signal.

16. The method defined in claim 15, wherein determining the color-specific, intensity-specific, location-specific correction factor based on the received display control signal comprises:
with the display control circuitry, determining the color-specific, intensity-specific, location-specific correction factor based on the color to be displayed by the selected pixel.

17. The method defined in claim 13, further comprising:
with the display control circuitry, determining an intensity of light to be displayed by the display pixel based on the received display control signal.

18. The method defined in claim 17, wherein determining the color-specific, intensity-specific, location-specific correction factor based on the received display control signal comprises:
with the display control circuitry, determining the color-specific, intensity-specific, location-specific correction factor based on the intensity of light to be displayed by the display pixel.

19. The method defined in claim 13, further comprising:
with the display control circuitry, determining a location of the display pixel in the display.

20. The method defined in claim 19, wherein determining the color-specific, intensity-specific, location-specific correction factor based on the received display control signal comprises:
with the display control circuitry, determining the color-specific, intensity-specific, location-specific correction factor based on the location of display pixel.

21. An electronic device, comprising:
a display having an array of display pixels, wherein each display pixel has a location on the display;
storage and processing circuitry configured to generate display data for the display, wherein the display data includes color information and intensity information for each pixel; and
display control circuitry configured to determine correction factor information based on the color information for each display pixel, the intensity information for each display pixel, and the location of each display pixel.

22. The electronic device defined in claim 21, wherein each display pixel in the array of display pixels comprises a red subpixel, a green subpixel, and a blue subpixel and wherein the correction factor information comprises a red correction factor for each red subpixel, a green correction factor for each green subpixel, and a blue correction factor for each blue subpixel.

23. The electronic device defined in claim 21, wherein the display control circuitry comprises a display timing controller integrated circuit.

24. The electronic device defined in claim 21, wherein the display control circuitry comprises a graphics controller.

25. The electronic device defined in claim 21, wherein the display data comprises at least one digital display control value, wherein the correction factor information comprises at least one correction factor between 0 and 1, and wherein the display control circuitry is configured to supply adapted display data to the display by applying the at least one correction factor to the at least one digital display control value.
